(19) United States
(12) Patent Application Publication
(10) Pub. No.: US 2017/0188524 A1
(43) Pub. Date: Jul. 6, 2017

(54) PLANT SUPPORT AND GROWTH DIRECTING APPARATUS AND METHOD OF USE

(71) Applicants: Christopher di Muro, Richmond, VT (US); Lindsey di Muro, Richmond, VT (US)

(72) Inventors: Christopher di Muro, Richmond, VT (US); Lindsey di Muro, Richmond, VT (US)

(21) Appl. No.: 15/338,359

(22) Filed: Oct. 29, 2016

Related U.S. Application Data
(60) Provisional application No. 62/249,005, filed on Oct. 30, 2015.

(51) Int. Cl. A01G 9/12

(52) U.S. Cl. CPC A01G 9/128

(57) ABSTRACT

This invention is a plant support and growth directing apparatus to enhance growth of a plant and increase product production from the plant by increasing air and light to a plant's canopy. The apparatus has at least one post and at least one crown attached thereto. At least one of the crowns has a plurality of spaces or openings sized and configured to receive and support branches of a plant to define a user desired growing pattern of the plant. In one configuration, the spaces are interstitial between coils of a coiled member, such as a spring, that is attached to or part of the crown. The crown may also be surfaced with an abrasive material such as a sand or polymer grit thereby more effectively holding the plant in place and providing a means to abrade or stress the plant to stimulate a growth response.

### CROSS REFERENCE TO RELATED APPLICATION

This Application claims priority from the Applicant's Provisional Patent Application Number 62/249,005 which was filed on Oct. 30, 2015.

### STATEMENT AS TO RIGHTS TO INVENTIONS MADE UNDER FEDERALLY SPONSORED RESEARCH OR DEVELOPMENT

Not applicable.

### REFERENCE TO A SEQUENCE LISTING, A TABLE OR A COMPUTER PROGRAM LISTING APPENDIX SUBMITTED ON A COMPACT DISC

Not Applicable.

### FIELD OF THE INVENTION

This invention relates generally to plant accessories, and more particularly, to supports for plants which may be used for controlling or directing plant growth. This invention also relates to the methods of using the invention to maximize the vitality, growth and in some instances appearance of plants such as in ornamental plants in a wide variety of applications including indoor and outdoor environments and support a plant in a manner that separates plant parts to improve the amount of air and light that is beneficially received by the plant.

### BACKGROUND

According to Genesis 2:15 and 3:23, the cultivation of plants and birth of agriculture appears to have occurred very soon after the dawn of man. Archaeological evidence of mankind's transition from hunter gatherer to agriculturalist or farmer exists all over the globe. For instance the cultivation of taro and yam in Papua New Guinea has been reliably dated back to at least 6950-6440 B.C.E. Dating from the time period of Egyptian cultures and other contemporary ancient cultures when mankind first developed written languages there exists a huge volume of writings containing in some instances very sophisticated agricultural processes that are thousands of years old.

Horticulture, however, is the branch of agriculture that deals with the art, science, technology, and business of growing plants, all of which are generally the subject of our invention. Horticulture includes the cultivation of medicinal plants, fruits, vegetables, nuts, seeds, herbs, sprouts, vegetables, nuts, seeds, mushrooms, algae, flowers, seaweeds and non-food crops such as grass and ornamental trees and plants. It also includes plant conservation, landscape restoration, landscape and garden design, construction, and maintenance, and arboriculture. Horticulture contrasts with the agricultural practices of extensive field farming as well as animal husbandry.

The study and science of horticulture dates back to the time of Cyrus the Great of ancient Medo-Persia circa 537 B.C.E. Advances in the disciplines of biological and chemical sciences, not the least of which being selective breeding, chemical fertilization (chemical nitrogen fixation) and genetic engineering have all led to advances in plant science and agricultural economics upon which the 21^{st} century world depends.

Horticulturists apply their knowledge, skills, and technologies used to grow intensively produced plants for human food and non-food uses and for personal, recreational or social needs. Their work involves plant propagation and cultivation with the aim of improving plant growth, yields, quality, nutritional or medicinal value concentration or potency, and resistance to insects, diseases, and environmental stresses. They work as gardeners, growers, therapists, designers, and technical advisors in the food and non-food sectors of horticulture. Horticulture even refers to the growing of plants in a field or garden.

Horticulturists have found that it is possible to manipulate the growth of plants to conform to a desired growth pattern. Such manipulation techniques that enhance growth are generally known as “training” the plant. In most cases training involves the bending of a portion of a plant in order to control the manner and direction in which the plant grows in a desired manner. It is well known that the yield of any particular plant is directly related to the plant's exposure to a light source, natural or artificial, upon which the plant depends for photosynthesis. Therefore one of the primary objects of training a plant is to maximize light exposure. Some horticulturalists have concluded that such factors as wind direction, wind speed and direction of growth in relation to the rotation of the earth and the magnetic poles of the earth may positively influence the growth of plants. One of the objects of our invention is to permit a user to direct the growth of a plant to take advantage of these beneficial factors.

Many different implements have been used to train plants which include such things as netting, cages, slitted tubes, twist ties, Velcro® straps, pipe cleaners, rubber bands, strings and stakes, etc. These implements are not only cumbersome and difficult to adjust with plant growth they are also quite time consuming to use and as a plant grows it shifts all of the ties, often requiring frequent alterations be made. These implements often interfere with one another which can cause tangling and knotting that may train the plant in an undesired manner.

It is fairly common for plants to become damaged during the course of their growth, however, it is well known that this damage may actually be advantageous, especially if controlled. In many cases horticulturalists often intentionally damage or stress plants in order to stimulate a growth and healing response that will ultimately increase the plant yield and facilitate the training of the plant. One such technique called “super cropping” which typically involves either “high stress” such as “cracking” of a user desired portion of the plant and “low stress” training which is discussed below. In super cropping the plant limbs are twisted (cracked) in order that the fibrous elements within the plant's stem are damaged thereby forcing the plant to respond to the injury and repair the damage initiating a phytohormone hormonal response within the plant thereby creating a stronger plant. Super cropping is done by hand and is difficult to control and often leads to loss of the “cracked” stem and many times result in the killing of the plant. There appears to be no device available that would permit a user to train the growth of a plant's limbs or branches that would: 1) be quick and easy to affix in a user desired position the desired plant stem or branch being trained; 2) be quick and easy to remove and readjust the desired plant stem or branch being trained as the plant grows; 3) permits a user to complete a controlled damage or stress to a plant to stimulate a growth and healing response that minimizes the risk of loss of a plant or plant stem often experienced in super cropping.

As is well known, there are a wide variety of different configurations of plant supports that are beneficially utilized to support a plant as it grows. One common type of plant support is a stake that is driven into the ground, typically relatively near the main stem of the plant, to which the plant is secured with wire, string, rope or other securing members. One concern with using a stake is that the person driving the stake in the ground must be as careful as possible, which is often hard to achieve, not to damage the roots of the plant, especially the taproot. Typically, only one stake is utilized if the only support that is needed is for the main stem. If the plant needs support for its branches or limbs, the user usually attaches one or more lateral support members to the stake or, often more common, has to use multiple stakes in the soil around the main stem. Naturally, the use of multiple stakes increases the likelihood that the roots of the plant will be damaged by one or more of the stakes. Instead of using multiple stakes when support is needed for the branches and limbs of the plant, particularly in an area having multiple plants, users commonly use trellises, netting and the like. One common type of trellis support system comprises a plurality of vertical support members interconnected by a plurality of generally laterally and/or angularly positioned support members that are attached to and often interconnect the vertical support members. The trellis support members are commonly made of wood, metal, plastic, fiberglass and the like. Another type of trellis system uses wire, rope, string or like elongated members configured in an interconnected grid to support the branches, limbs and other plant parts, including often the produce. While the use of multiple stakes, trellises, nets and the like have a number of benefits with regard to better supporting many types of plants, they do have a number of limitations, particularly with other types or varieties of plants. One such limitation is that because of their configuration these types of support systems are difficult to arrange so that they can beneficially train the plant to grow in the manner in which the user believes will benefit the plant and the produce to be produced therefrom. Generally, using multiple stakes does not provide a useful framework for training the branches and limbs to grow in the manner that is desired by the user. Trellis and grid systems usually cut down on the number of stakes that are required to support the plants, and in some configurations can even eliminate the use of stakes, and generally allow the user to better train the plants by moving the wires, ropes, strings or other elongated members as necessary to adjust for plant growth. Unfortunately, depending on the growth rate of the plant and necessary training, this can require the user to frequently move or otherwise adjust the elongated members to obtain the desired training of the plants. With regard to training the plants for improved light into the center of the plant, because the trellis system is usually placed over the plants, a possible unintentional effect of the trellis system is to block sunlight or other light from reaching the interior and lower areas of the plant. With regard to harvesting the produce of the plant, the various elongated members and other components of the trellis system can get in the way of harvesting, causing the harvesting process to be more difficult and to take longer than would otherwise be necessary.

Another limitation to the use of trellises, grids, nets and the like is that the growing area for the plant is generally defined and somewhat limited by the boundaries of such systems. While this is typically not a problem for those plants which are grown in the ground, many users prefer to grow the plants in pots, buckets, planters and like containers (which are collectively referred to as pots) because they can more easily access the plants for trimming, treating and harvesting the plants and to move or rotate the plants as necessary for improved access to light, water or for other purposes. As such, the use of most types of trellises, grids, nets and like support systems can cause unintended, but hard to avoid, difficulties or limitations with growing plants when the plants are grown in pots. As readily appreciated by those skilled in the art of growing plants in pots, the use of such support systems results in loss of some of the benefits of growing plants in pots. As well known in the art, virtually all plants have evolved to grow in particular growth patterns in the wild that optimize the plant's exposure to sunlight as the sun travels in an arc across the sky during the day. However, for a variety of reasons, many people prefer to grow certain plants, particularly those in the Cannabis family, indoors using indoor lights for the necessary light and fans for the airflow. Because indoor growing facilities normally have stationary light sources, the plant's natural growth patterns may not be very efficient for indoor harvesting of these plants. Efforts have been made to provide systems that better optimize light exposure for indoor plant cultivation, such as providing moving lamps, support sticks and the like. However, as well known in the art, growing improvements such as these are generally somewhat expensive and/or tedious to install. Furthermore, as set forth above, many plant supports and common wire plant cages are fixed and, therefore, cannot be adapted for changing growth habits of individual plants.

Relatively recently, the harvesting of plants in the Cannabis family has become much more wide-spread and commercialized. The natural growth pattern of Cannabis plants produces a generally triangular-shaped plant. As generally well known in the art of growing such plants, the optimization of the growth of and production from Cannabis plants typically involves arranging multiple support sticks around a plant to provide support and guidance for the branches and limbs of the plant. Although the process of arranging the support sticks is tedious, labor intensive and often requires a significant amount of time to implement, most users consider such plant supports necessary to “combat” the natural growth pattern of Cannabis plants. The natural triangle shape of Cannabis plants is known to limit the amount of air and light that reaches the interior branches and limbs of the plant, which significantly reduces the amount the plant will produce. Spreading out the limbs and branches of a Cannabis plant is known to benefit the growth of the plant and to increase the amount of plant production.

With respect to plants, and in particular regarding the Cannabis plant (including Cannabis sativa and Cannabis indica), growth and development is dictated by the dominant apical meristem of the plant. The dominant apical meristem is the main shoot or dominant central stem of a plant where plant growth originates. Growth of plants is focused at the apical meristem such that secondary shoots originating from the apical meristem grow less rapidly than the apical meristem does. Traditionally, in the wild, many plants, such as, but not limited to, those within the Cannabis family, have a single dominant apical meristem that creates a Christmas tree-like or triangular growth pattern. This pattern optimizes a plant's ability to absorb light in the wild from the sun's exposure as it arcs across the sky during the course of the day. However, this growth pattern is inefficient when these plants are cultivated indoors and when an overhead stationary light source is used because the stationary light source does not adequately provide light to all parts of the plant, resulting in uneven growth and a waste of light and plant resources. Accordingly, current industry techniques attempt to induce horizontal growth of plants over vertical growth, such that a plant may better utilize light generated at a stationary indoor light source. These techniques include topping, super cropping, and low stress training.

Topping is employed by removing the top of the main shoot, or apical meristem, to transfer apical dominance (i.e., the tendency for the apex to grow more rapidly than the rest of the plant) to the shoots emanating from the two nodes immediately beneath the pruning cut. This process may be repeated at the two new secondary shoots, and so on. Removal of the top of the dominant apical meristem inhibits vertical growth and encourages the plant to grow horizontally into a bush having more secondary shoots, rather than vertically through the apical meristem. This technique allows the traditional Christmas tree—like shape of many plants, such as, but not limited to, those within the Cannabis family, to become more flat at the top and form more of a martini glass-like shape. As a result, this shape allows for more horizontal surface area of the plant, which increases light absorption by the plant from a stationary light source.

There is an optimal level of light intensity to growing indoors (a.k.a. Absorption Horizon™). The distance from a plant to its light source is crucial to the life and development of the female flowers in order to maximize and benefit from its food source (a.k.a. light). If the canopy is too close to the light source, it will burn, wilt, and potentially die. Contrarily, if the canopy is too far away from the light source, development will be hindered and underdeveloped. Premature flowers will result. This condition is what we call the Absorption Horizon™.

Another common technique is super cropping (also known as high stress training or pinching). Super cropping involves firmly pinching the apical meristem of the plant so as to damage the apical meristem tissue to cause lower limbs of the plant to grow more rapidly while the pinched tissue heals. By increasing growth at a plant's lower sites, away from where the damage occurred, the plant's growth pattern becomes shorter and more horizontal, resulting in increased light absorption by the plant from a stationary light source.

Low stress training (LST) is an additional method for inducing horizontal plant growth. Here, a user pulls a plant in a downward direction to force more lateral growth of the plant and to increase light exposure to lower branches of the plant from an overhead stationary light source. In particular, LST involves tying down a plant to hold the induced downward position and to force lateral growth of the plant. In addition, LST may be used in conjunction with topping or super cropping (e.g., after implementing the topping or super cropping techniques). However, although LST may be effective for inducing lateral plant growth to increase plant light absorption, it may be a time consuming process in tying down a plant at several locations as the plant grows.

Despite the existing support apparatuses and the use of the foregoing growing techniques, there exists a need for an improved apparatus for supporting a plant as it grows. The improved plant support and training apparatus should be configured to spread out the plant's limbs and branches to improve airflow and light to the interior of the plant and to support those parts of the plants, including branches and limbs, that are likely to break or otherwise be damaged by the weight of the plant part or the produce growing from the plant part. Preferably, the improved plant support and training apparatus should limit the number of stakes that are driven into the soil around the stem of the plant to reduce the likelihood of damaging the plant's root system. The improved plant support and training apparatus should also be configured to allow the user to be able to train the plant to grow in the manner that he or she desires to improve the growth and production of the plant. The improved plant support and training apparatus should also be configured to be beneficially utilized with plants grown in pots by allowing the user to still be able to move, rotate or otherwise change the location of the plant pot. Preferably, the improved plant support and training apparatus will be adaptable to a wide range of plants and be able to be inexpensively manufactured.

The subject matter discussed in this background section should not be assumed to be prior art merely as a result of its mention in the background section. Similarly, a problem and the understanding of the causes of a problem mentioned in the background section or associated with the subject matter of the background section should not be assumed to have been previously recognized in the prior art. The subject matter in the background section may merely represent different approaches, which in and of themselves may also be inventions.

### Disclosure of the Invention

The apparatus and system for supporting and training plants of the present invention solves the problems and provides the benefits identified above. That is to say, the present patent application discloses a plant support and training apparatus which is structured and arranged to overcome the natural growing pattern of the plant to increase the amount of air and light received by the interior of the plant and to support the plant as it grows in soil or other growing mediums. More specifically, the plant support and training apparatus of the present invention is structured and arranged to beneficially spread out the limbs and branches of a plant to allow more air and light to reach the interior portion of the plant and to support its branches and limbs that are likely to break or otherwise be damaged by the weight of the plant part itself or the produce that is growing from the plant part. Use of the plant support and training apparatus of the present invention substantially reduces the number of stakes that are required to be driven into the soil around the stem of the plant, which significantly reduces the likelihood that the plant's root system will be damaged by the new plant support and training apparatus. The new plant support and training apparatus facilitates the user being able to train the plant so the plant will grow in the manner desired.

In one use of the new plant support and training apparatus the user can direct the branches and limbs so they are generally spread apart to increase the amount of light and air into the central part of the plant and facilitate inspection and, as needed, treatment of the plant. The plant support and training apparatus of the present invention can be beneficially utilized with plants grown in pots to allow the user to be able to move, rotate or otherwise change the location of the plant pot while the plant is still growing in the pot. In preferred configurations, the plant support and training apparatus of the present invention is adaptable to a wide range of plants and is able to be inexpensively manufactured.

In one aspect of the present invention, the plant support and training apparatus is configured to support and train one or more branches of a plant that is growing in soil so as to establish a circular growing pattern for the plant that will provide more air and light for the center area of the plant. In one embodiment, the apparatus has an elongated post, one or more support arms and a coiled member associated with at least one of the support arms. The post has a post body having a lower end and an upper end, with the lower end of the post body being adapted to be placed on or in the soil. Each of the support arms has an elongated arm body with a first end and a second end, with the arm body being attached to or integral with the upper end of the post body. The coiled member has a coiled-shaped body with a first end, a second end and a plurality of coils. The first end of the coiled-shaped body is attached to or integral with the first end of the arm body and the second end of the coiled-shaped body is attached to or integral with the second end of the arm body. The coils define a plurality of gaps or interstitial spaces, with each being sized and configured to receive and support at least one of the branches of the plant to define the desired circular growing pattern thereof. In one embodiment, the support arm has a generally u-shaped arm body and the coiled member is positioned in spaced apart relation to a top side of the arm body. In another embodiment, the apparatus has an attachment mechanism that movably attaches the support arm to the upper end of the post to allow the support arm to move relative to the upper end of the post. In yet another embodiment, the apparatus has a connecting mechanism that is associated with each of the first end of the coiled-shaped body and the first end of the arm body and with each of the second end of the coiled-shaped body and the second end of the arm body. The connecting mechanism can be a pin at each of the first end and the second end of the coiled-shaped body and an aperture at each of the first end and the second end of the arm body, with the pin and the aperture being cooperatively configured to secure the coiled-shaped body to the arm body. If desired, at least one of the support arms can include a pivot device that allows one portion of the support arm to pivot relative to another portion of the support arm for plants at or near the outer footprint of the light from the light source. In one configuration, the apparatus has a first support arm, a second support arm and a third support arm, with each of the first support arm and the third support arm having a coiled member.

Accordingly, the primary object of the present invention is to provide an apparatus for supporting and training plants that has the various advantages set forth above and elsewhere in the present disclosure and which overcomes the disadvantages and limitations associated with presently available apparatuses for supporting a plant while it grows and is harvested. It is also an important objective of the present invention to provide a plant support and training apparatus that helps the user to overcome the natural growth patterns of a plant to increase the amount of air and light that reach the interior of the plant and to support the limbs and branches of the plant as it grows.

An important aspect of the present invention is that it provides a new plant support and training apparatus that achieves the various objectives set forth above and elsewhere in the present disclosure. It is an important aspect of the present invention to provide a plant support and training apparatus that is structured and arranged to allow the user to be able to better train the plant to grow in the manner he or she desires.

It is an important aspect of the present invention to provide a plant support and training apparatus that is structured and arranged to spread out the limbs and branches of the plant to increase the amount of air and light which reach the interior of the plant to improve plant growth and production and to facilitate treating the plant.

It is also an important aspect of the present invention to provide a plant support and training apparatus that is structured and arranged to support a plant in a manner that supports those parts of a plant, including its branches and limbs, that are likely to break or otherwise be damaged by the weight of the plant part itself or by the produce that is growing from the plant part.

It is also an important aspect of the present invention to provide an improved plant support and training apparatus that substantially reduces the number of stakes that are required to be driven into the soil around the stem of the plant to reduce the likelihood that the plant's root system will be damaged.

It is also an important aspect of the present invention to provide an improved plant support and training apparatus that can be easily and beneficially utilized with plants which are being grown in pots in order to allow the user to move, rotate or otherwise change the location of the plant pot, as may be desired or necessary to benefit the plant, while the plant is still growing in the pot or transplanted to another pot. The present invention facilitates the attachment and removal of user selected plant components by incorporation of a coiled spring or continuous looped member that can be stressed and relaxed to effectively hold and/or release the plant by the stored energy exerted on the interstitial spaces between the coils or loops. An abrasive surface on the device permits a user to controllably abrade or stress the plant components and more effectively holding the plant component in place minimizing the plant component from sliding to a less desirable position.

Another important aspect of the present invention is to provide an improved plant support and training apparatus that is adaptable to a wide range of different types of plants and plant pots. Yet another important aspect of the present invention is to provide an improved plant support and training apparatus that is generally inexpensive to manufacture and easy to use.

As will be explained in greater detail by reference to the attached figures and the description of the preferred embodiment which follows, the above and other objects and aspects are accomplished or provided by the present invention. As set forth herein and will be readily appreciated by those skilled in the art, the present invention resides in the novel features of form, construction, mode of operation and combination of processes presently described and understood by the claims.

The description of the invention which follows is presented for purposes of illustrating one or more of the preferred embodiments of the present invention and is not intended to be exhaustive or limiting of the invention. The scope of the invention is only limited by the claims which follow after the description.

### BRIEF DESCRIPTION OF THE DRAWINGS

The accompanying drawings, which are incorporated herein and constitute part of this specification, depict example embodiments of the disclosure, and together with the general description given above and the detailed description given below, serve to explain the features of the various embodiments.

FIG. 1 depicts a perspective view of a hexagonally shaped combination rectangularly and trapezoidally patterned post and crown embodiment of a Plant Support and Growth Directing Apparatus.

FIG. 2A depicts a top view of a hexagonally shaped and trapezoidally patterned post and crown embodiment Plant Support and Growth Directing Apparatus.

FIG. 2B depicts a perspective view of the Plant Support and Growth Directing Apparatus shown in FIG. 2A.

FIG. 2C depicts a cutaway view of a portion of the Plant Support and Growth Directing

Apparatus shown in FIG. 2A and FIG. 2B showing the abrasive surface disposed thereon.

FIG. 3A depicts a top view of a combination rectangular and triangular patterned component post and crown embodiment of a Plant Support and Growth Directing Apparatus according to various embodiments.

FIG. 3B depicts a perspective view of the Plant Support and Growth Directing Apparatus shown in FIG. 3A.

FIG. 3C depicts a cutaway view of a portion of the Plant Support and Growth Directing Apparatus shown in FIG. 3A and FIG. 3B showing the abrasive surface disposed thereon.

FIG. 4A depicts a side view of a wing shaped component post and crown embodiment of a Plant Support and Growth Directing Apparatus tethered to a post.

FIG. 4B depicts a side view of the Plant Support and Growth Directing Apparatus shown in FIG. 4A in an untethered condition.

FIG. 4C depicts a top view of the Plant Support and Growth Directing Apparatus shown in FIG. 4B.

FIG. 4D depicts a top view of the Plant Support and Growth Directing Apparatus shown in FIG. 4A showing the detachability of the apparatus′ component parts.

FIG. 5 depicts a top view of a fan shaped lattice component post and crown embodiment of a Plant Support and Growth Directing Apparatus including a tether to the post.

FIG. 6 depicts a perspective view of a Plant Support and Growth Directing Apparatus with a upward tethering and arm support system.

FIG. 7A depicts a top view of a tight coil component post and crown embodiment of a Plant Support and Growth Directing Apparatus.

FIG. 7B depicts a perspective view of the Plant Support and Growth Directing Apparatus shown in FIG. 7A.

FIG. 8 depicts a top view of a relaxed coil or whip component post and crown embodiment of a Plant Support and Growth Directing Apparatus.

FIG. 9A depicts a top view of a curved top T-shaped component post and crown embodiment of a Plant Support and Growth Directing Apparatus.

FIG. 9B depicts a top view of a notched open circle component post and crown embodiment of a Plant Support and Growth Directing Apparatus

FIG. 10 depicts a side view of a cantilevered support post and crown embodiment of a Plant Support and Growth Directing Apparatus according to various embodiments.

FIG. 11A depicts a side view of a rounded umbrella shaped component post and crown embodiment of a Plant Support and Growth Directing Apparatus utilizing chainmail.

FIG. 11B depicts a side view of a straight umbrella shaped component post and crown embodiment of a Plant Support and Growth Directing Apparatus utilizing chainmail.

FIG. 12 depicts a top view of a cantilevered sail shaped lattice component post and crown embodiment of a Plant Support and Growth Directing Apparatus.

FIG. 13A depicts a top view of a cantilevered flag shaped lattice component post and crown embodiment of a Plant Support and Growth Directing Apparatus according to various embodiments.

FIG. 13B depicts a perspective view of the Plant Support and Growth Directing Apparatus shown in FIG. 13A.

FIG. 14A depicts a top view of a pyramid shaped lattice post and crown embodiment of a Plant Support and Growth Directing Apparatus.

FIG. 14B depicts a perspective view of the Plant Support and Growth Directing Apparatus shown in FIG. 14A.

FIG. 15A depicts a perspective view of a star shaped lattice post and crown embodiment of a Plant Support and Growth Directing Apparatus.

FIG. 15B depicts a top view of the Plant Support and Growth Directing Apparatus shown in FIG. 15A.

FIG. 16 depicts a top view of weaving stems of a plant through a Plant Support and Growth Directing Apparatus according to all of the disclosed embodiments.

FIG. 17 depicts a top view of a spring component post and crown embodiment of a Plant Support and Growth Directing Apparatus.

FIG. 18A depicts a top view of a cantilevered spring post and crown embodiment of a Plant Support and Growth Directing Apparatus.

FIG. 18B depicts a side view of the Plant Support and Growth Directing Apparatus shown in FIG. 18A tethered to a post.

FIG. 19 depicts a top view of a saw blade pattern component post and crown embodiment of a Plant Support and Growth Directing Apparatus according to various embodiments.

FIGS. 20A-20F depict top views of various shaped post and crown embodiments of a Plant Support and Growth Directing Apparatuses.

FIG. 21 depicts a flow chart showing a method of use of a Plant Support and Growth Directing Apparatus according to all the disclosed embodiments.

FIG. 22 depicts a top view of a Plant Support and Growth Directing Apparatus configured according to an alternative embodiment of the present invention having multiple Plant Support and Growth Directing Apparatuses.

FIG. 23 depicts an isolated top view of one of the Plant Support and Growth Directing Apparatuses of the Plant Support and Growth Directing Apparatus of FIG. 22.

FIG. 24A depicts a side view of a non-adjustable tensile resistance coiled spring plant member retaining embodiment of a Plant Support and Growth Directing Apparatus.

FIG. 24B is a cutaway side view of the abrasive material coated coiled spring that comprises an elastic object capable of storing mechanical energy component of the Plant Support and Growth Directing Apparatus depicted in FIGS. 24A,C,D,E,H,I,J,K, & L.

FIG. 24C depicts a side view of an adjustable tensile resistance coiled spring plant member retaining embodiment of a Plant Support and Growth Directing Apparatus with a plant operatively attached to the apparatus with one branch of which has been supercropped.

FIG. 24D depicts a side view of an adjustable tensile resistance coiled spring plant member retaining embodiment of a Plant Support and Growth Directing Apparatus with a plant that has been harvested and remains attached to the apparatus while inverted for drying or other user desired processing of the plant.

FIG. 24E depicts a side view of an adjustable tensile resistance continuous loop plant member retaining embodiment of a Plant Support and Growth Directing Apparatus with a continuous loop variable resistance adjustment knob shown in the released position.

FIG. 24F is a cutaway side view of the adjustable tensile resistance continuous loop plant member retaining embodiment of a Plant Support and Growth Directing Apparatus with a continuous loop variable resistance adjustment knob shown in the released position thereby retaining a user selected portion of a plant by the continuous loop's tensile mechanical energy within the continuous loop.

FIG. 24G is a cutaway side view of the adjustable tensile resistance continuous loop plant member retaining embodiment of a Plant Support and Growth Directing Apparatus with a continuous loop variable resistance adjustment knob shown in the fully engaged position thereby opening the interstitial spaces between the loops thereby permitting a user selected portion of a plant to either be placed of removed from the continuous loop.

FIG. 24H is a cutaway side view of the adjustable tensile resistance coiled spring plant member retaining embodiment of a Plant Support and Growth Directing Apparatus with a coiled spring variable resistance adjustment knob shown in the released position thereby retaining a user selected portion of a plant by the coiled spring's tensile mechanical energy within the interstitial spaces between the coils of the coiled spring.

FIG. 24I is a further cutaway side view of the adjustable tensile resistance coiled spring plant member retaining embodiment of a Plant Support and Growth Directing Apparatus shown in the released position thereby retaining a user selected portion of a plant by the coiled spring's tensile mechanical energy within the interstitial spaces between the coils of the coiled spring.

FIG. 24J is a cutaway side view of the adjustable tensile resistance coiled spring plant member retaining embodiment of a Plant Support and Growth Directing Apparatus with a coiled spring variable resistance adjustment knob shown in the fully engaged position thereby opening the interstitial spaces between the loops thereby permitting a user selected portion of a plant to either be placed or removed from the interstitial spaces between the coils of the coiled spring.

FIG. 24K is a further cutaway side view of the adjustable tensile resistance coiled spring plant member retaining embodiment of a Plant Support and Growth Directing Apparatus with a coiled spring shown in the fully engaged position thereby opening the interstitial spaces between the loops thereby permitting a user selected portion of a plant to either be placed or removed from the interstitial spaces between the coils of the coiled spring.

FIG. 24L is a front view of a non-adjustable tensile resistance coiled spring plant member retaining embodiment of a Plant Support and Growth Directing Apparatus that is configured according to a second embodiment of the non-adjustable tensile resistance coiled spring plant member retaining embodiment showing use of a pivot device to allow a second arm body to pivot relative to the first arm body, with each arm body having a coiled spring.

FIG. 25A is a cut away side view of a removable post stand embodiment of a Plant Support and Growth Directing Apparatus without any plant support components attached.

FIG. 25B is a top view of a removable post stand embodiment of a Plant Support and Growth Directing Apparatus without any plant support components attached depicting a plurality of post attachment holes.

FIG. 25C is a cut away side view of a removable post stand embodiment of a Plant Support and Growth Directing Apparatus without any plant support components attached depicting the removability from a pot.

FIG. 25D is a cut away side view of a removable post stand embodiment of a Plant Support and Growth Directing Apparatus with an attached adjustable tensile resistance coiled spring plant retaining member.

FIG. 25E is a cut away side view of a removable post stand embodiment of a Plant Support and Growth Directing Apparatus with two attached adjustable tensile resistance coiled spring plant retaining members.

### DETAILED DESCRIPTION

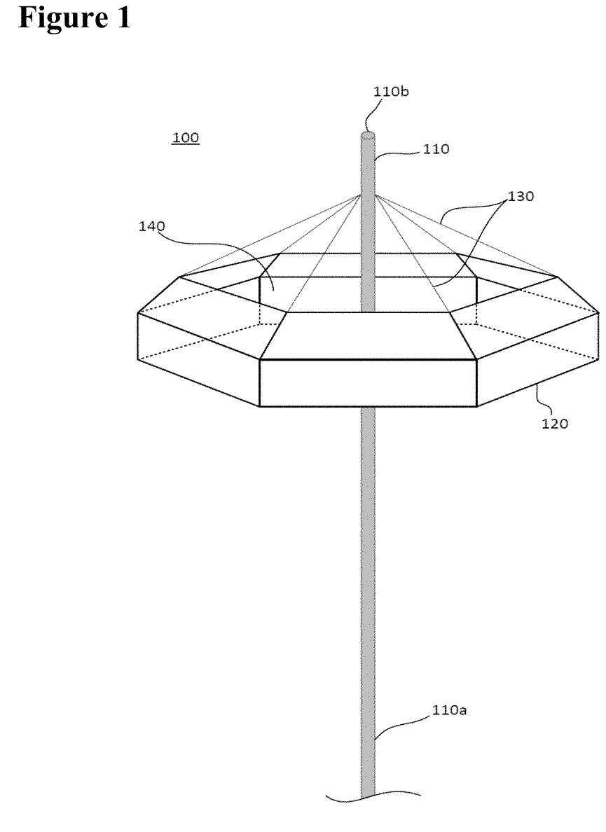

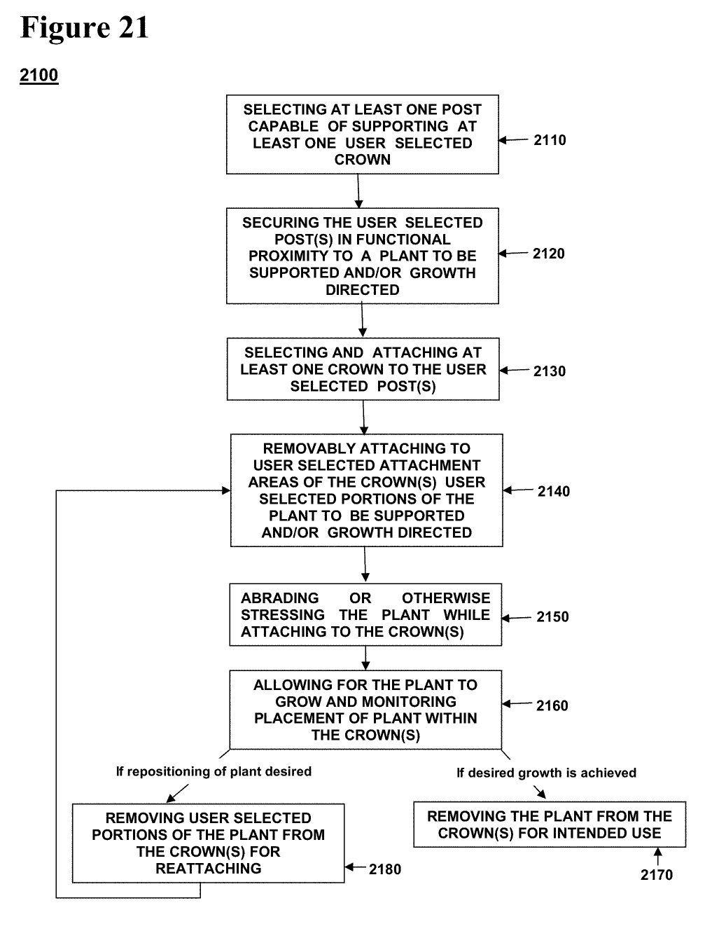

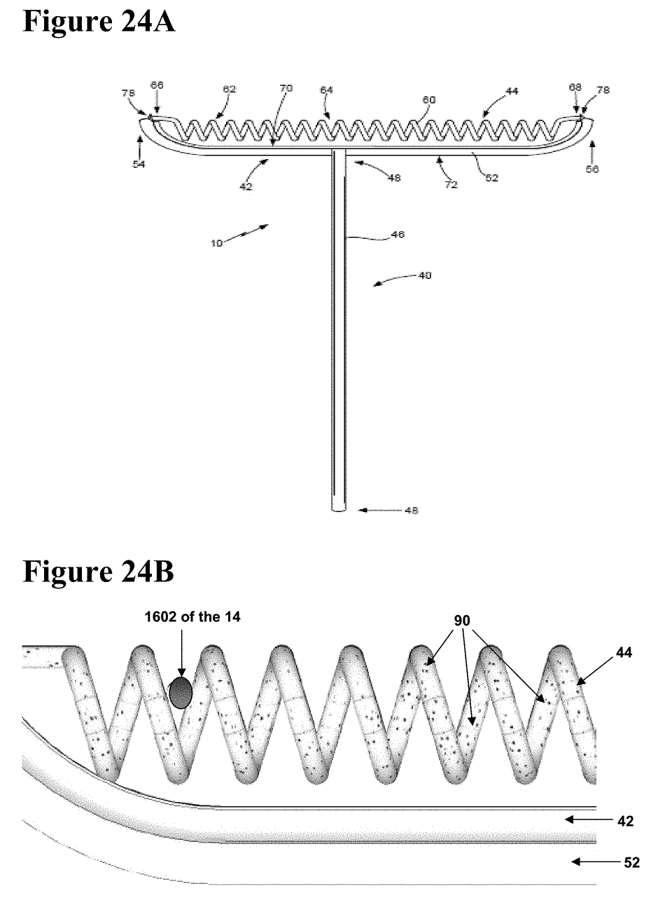

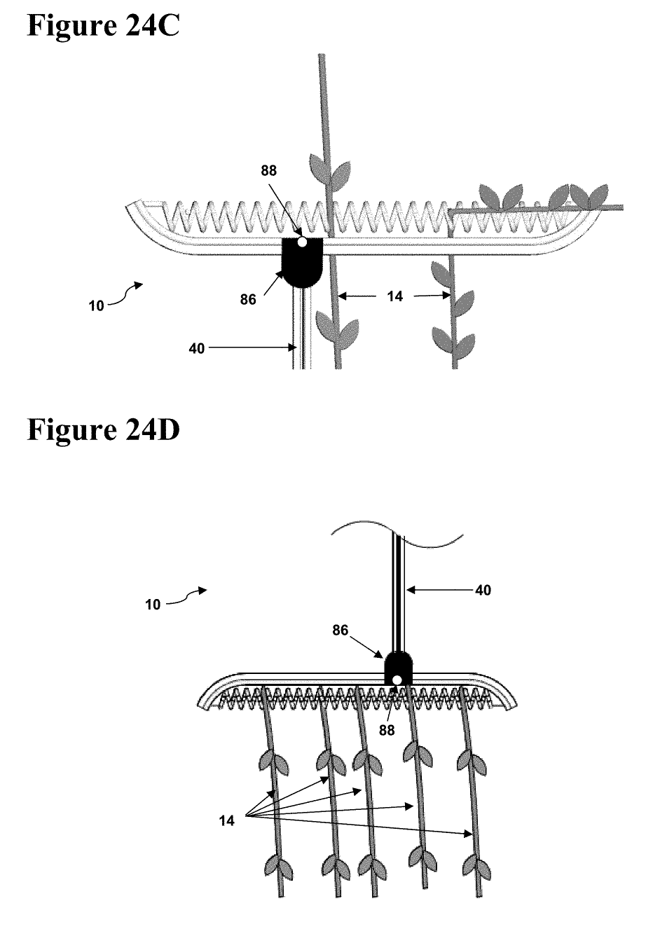

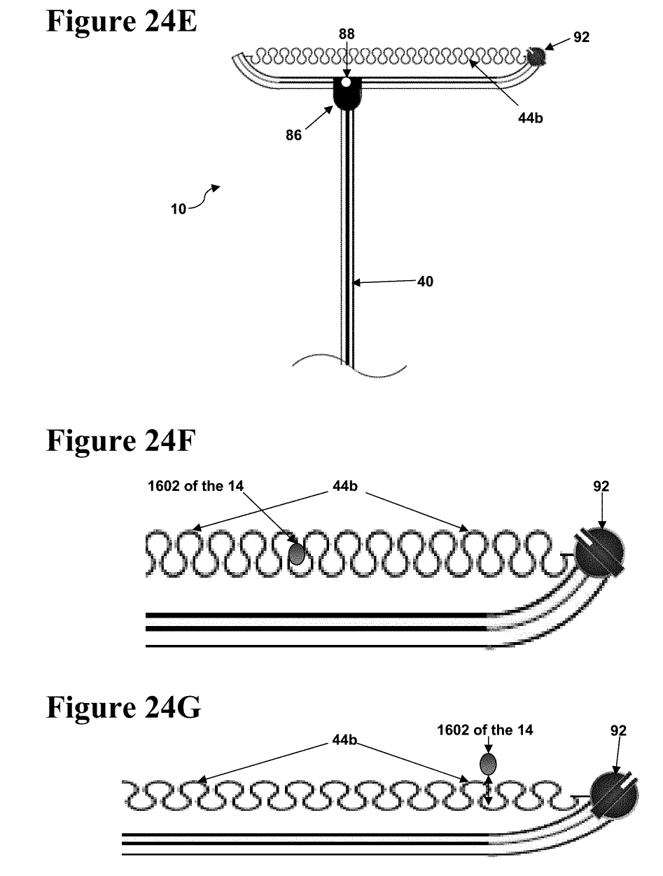

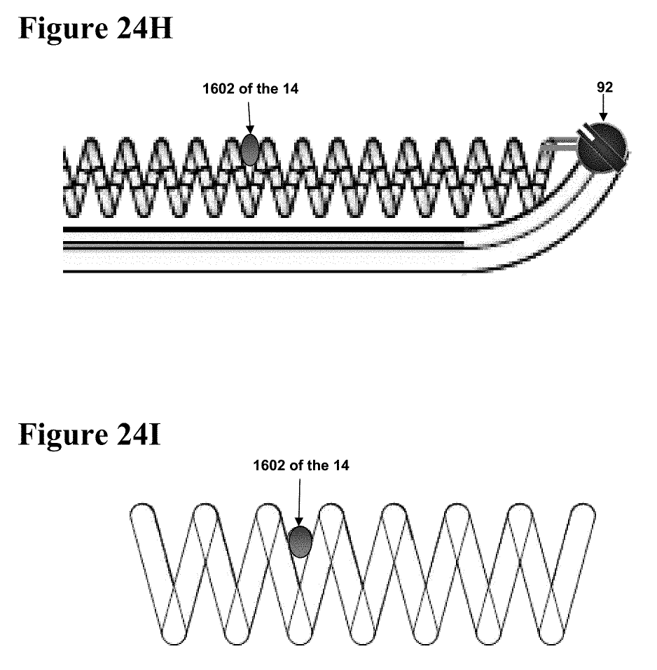

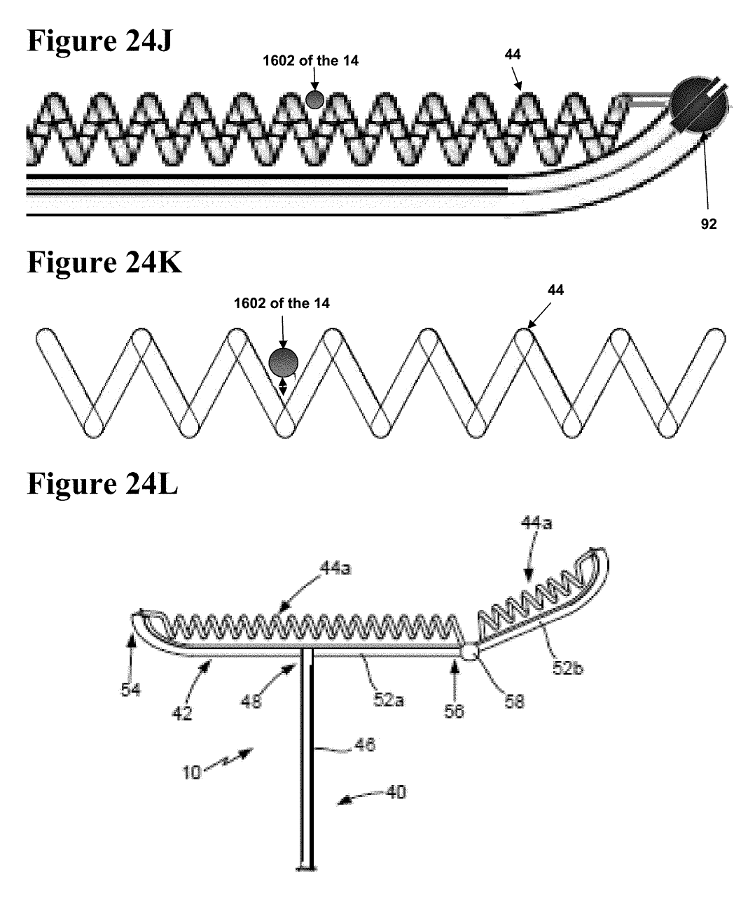

FIGS. 1-20 and 22-23 inclusive depict various configurations of various post and crown embodiments of a Plant Support and Growth Directing Apparatus. A user may select the configuration that best suits their needs which may be directed by the presence or absence of light, air movement, plant selection, plant yield, ornamental design or other aesthetic considerations, etc. FIG. 21 depicts a flow chart of the method of use of the Plant Support and Growth Directing Apparatus. FIGS. 24A-L inclusive depict various configurations of tensile resistance plant member retaining embodiments of a Plant Support and Growth Directing Apparatus.

FIG. 1 depicts a perspective view of a hexagonally shaped combination rectangularly and trapezoidally patterned post and crown embodiment of a Plant Support and Growth Directing Apparatus.

Referring to FIG. 1, a Plant Support and Growth Directing Apparatus 100 includes at least one Post 110, a Crown 120, and a plurality of Tethers 130. In some embodiments, the Plant Support and Growth Directing Apparatus 100 includes one Post 110. In other embodiments, the Plant Support and Growth Directing Apparatus 100 includes a plurality of Posts 110. In further embodiments, the Post includes a First End 110a and a Second End 110b. In some embodiments, the First End 110a of the Post 110 may be for depositing or rooting the Post 110 into the ground such that the Plant Support and Growth Directing Apparatus 100 securely stands upright for supporting a corresponding plant. According to various embodiments, the Post 110 may be made from any suitable rigid material such as, but not limited to, wood, metal, plastic, galvanized steel, wire (e.g., wire coated with rubberized plastic), a colored anodized aluminum, or the like.

In further embodiments, the Crown 120 is coupled to the Post 110. Further discussion regarding the coupling of the Crown 120 to the Post 110 is discussed below corresponding to various embodiments. The Crown 120 may be coupled to the Post 110 at any suitable location along the length of the Post 110, for example, at a location corresponding to a height of a plant. According to various embodiments, the Crown 120 may include a plurality of Facets, Chainmail, bent-metal constructs, or a concave wire structure (e.g., a “wave”), which are all discussed further below. According to various embodiments, a Facet includes a portion of a Crown 120 that includes a trellis for receiving and retaining branches of a plant that is to be supported by the Plant Support and Growth Directing Apparatus 100.

Particular embodiments of the Crown 120 may have various shapes and sizes. Further embodiments of the Crown 120 are discussed below. In various embodiments, the Crown 120 may provide a trellis (or a lattice screen) that arcs around the circumference of a supported plant's canopy. In particular embodiments, the Crown 120 may be equidistant from a center of a supported plant, for example, in embodiments where there is a single centered Post 110 and a Crown 120 surrounding the Post 110, or in embodiments where there are a plurality of bordering Posts located along the circumference or perimeter of the Crown 120 and surrounding the supported plant. In other words, the Crown 120 may surround a supported plant such that all edges of the Crown 120 are equidistant from the central stem (e.g., the apical meristem) of a supported plant. In some embodiments, the shape of the perimeter of the Crown 120 may be primarily circular, to correspond to the shape of a canopy of foliage. However, in other embodiments, the perimeter of the Crown 120 may be other shapes, such as, but not limited to, a square, a triangle, or any other suitable polygonal shape for supporting branches of a plant. In some embodiments, the Crown 120 may be made from, for example, but not limited to, metal, galvanized steel, wire (e.g., wire coated with rubberized plastic), a colored anodized aluminum, or the like.

In further embodiments, the Crown 120 may be connected to the Post 110 via a plurality of Tethers 130. Further disclosure regarding the Tethers 130 is discussed below. In various embodiments, the Crown 120 may have a structure such that there is an Empty Space 140 within the Crown 120. In some embodiments, a supported plant may grow within the Empty Space 140. In particular embodiments, the supported plant may be grown vertically along the Post 110 and then, after using techniques to encourage the plant to grow horizontally (e.g., topping, super cropping, and low stress training), the horizontally grown shoots or branches of the supported plant may be woven into the Crown 120 to further encourage the plant to grow at a consistent horizontal level such that the supported plant receives consistent light (e.g., from an overhead stationary lamp) at most or all portions of the plant. As such, a plant grown within the Plant Support and Growth Directing Apparatus 100 may have increased light absorption and therefore have increased yield from harvesting the plant.

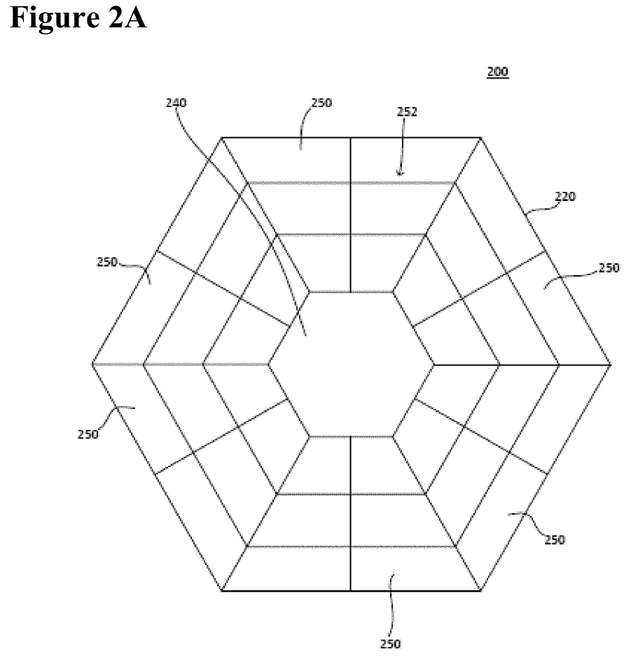

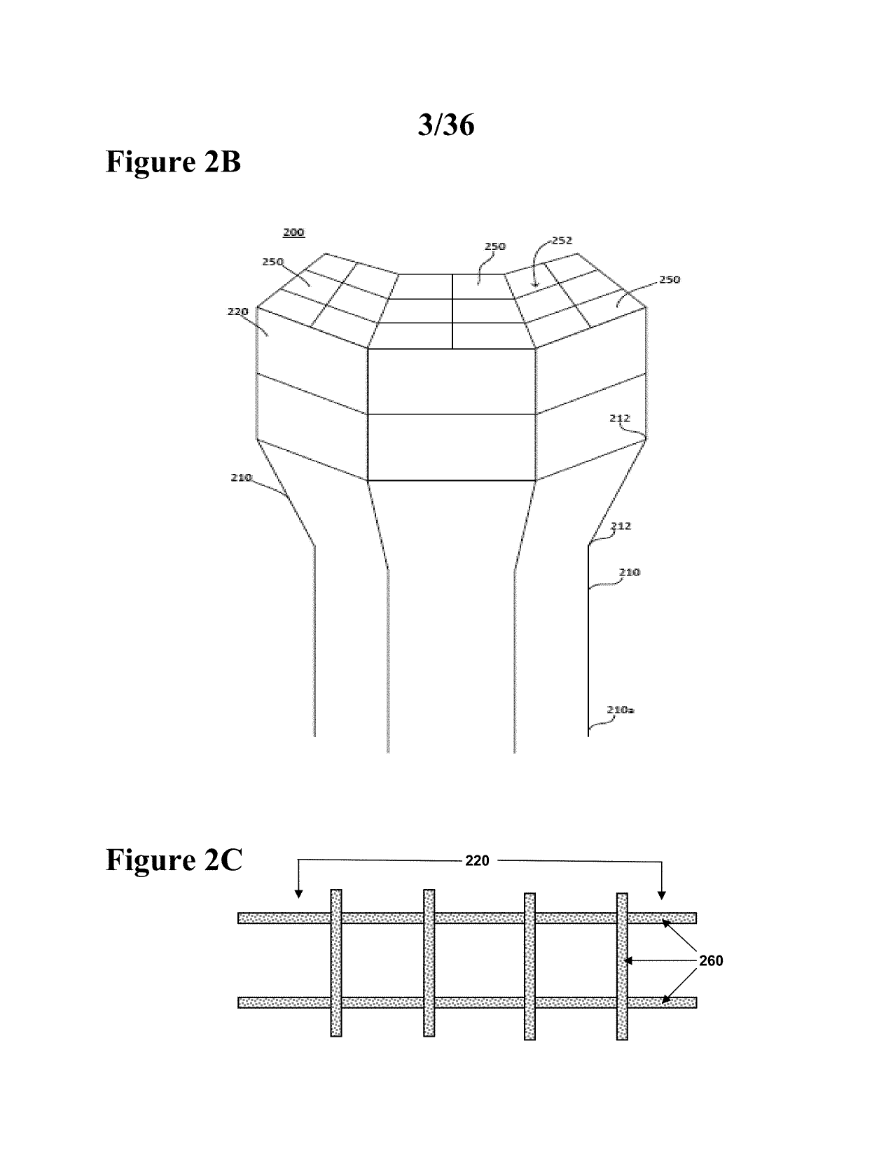

FIG. 2A depicts a top view of a hexagonally shaped and trapezoidally patterned post and crown embodiment Plant Support and Growth Directing Apparatus.

FIG. 2B depicts a perspective view of the Plant Support and Growth Directing Apparatus shown in FIG. 2A.

FIG. 2C depicts a cutaway view of a portion of the Plant Support and Growth Directing Apparatus shown in FIG. 2A and FIG. 2B showing the abrasive surface disposed thereon.

Referring to FIGS. 2A, 2B and 2C, a Plant Support and Growth Directing Apparatus 200 includes a plurality of Posts 210, a Crown 220 including a plurality of Facets 250, and Empty Space 240 in which a plant may be grown.

In some embodiments, the plurality of Posts 210 may be rooted and anchored into the ground at their First End 210a. In particular embodiments, the placement of each Post 210 may be suitably located to allow the supported plant to grow horizontally. For example, each Post 210 may be placed as close to the outer edge of the canopy's perimeter as possible. In particular embodiments, each Post 210 may have a plurality of Angled Locations 212. In some embodiments, each of the Posts 210 at each of the Angled Locations 212 are bent at the same degree of angle (e.g., each Post 210 is bent at an angle of about 135 degrees at each of the Angled Locations 212). Furthermore, each Angled Location 212 along the Post 210 may also be inverted from each other. In other words, a Post 210 having a first Angled Location 212 angling outwards away from the plant may have a second Angled Location 212 angling inwards towards the plant. By providing Angled Locations 212 along the Post 210, the Posts 210 are able to support a Crown having a wider perimeter, while the Posts at the First Ends 210a rooted into the ground need not use as wide of a perimeter. For example, a user having a small pot for growing a plant may utilize the angled Posts 210 to support a plant having a larger canopy, in contrast to if the user were to use substantially vertical or straight Posts. In further embodiments, the Post 210 may be manufactured as a plurality of separate components to be assembled by a user. In other embodiments, the Post 210 may be a single continuous Post. In some embodiments, the height of each Post 210 may be adjustable by adding or removing extensions at the Post 210. In some examples, the Posts 210 may be located at any suitable location of the Crown 220 for supporting the weight of the Crown 220. In particular embodiments, the Posts 210 may be located at each of the corners of the Crown 220. In other embodiments, the Posts 210 may be located at the lateral edges of the Crown 220 instead of, or in addition to, the corners of the Crown 220.

According to some embodiments, each of the Posts 210 may support a Facet 250. In other embodiments, more than one Post 210 may support a single Facet 250. The Facets 250 are what comprise the Crown 220, and when each Facet 250 is placed next to a neighboring Facet 250, the Crown 220 may be complete and may surround a canopy of a supported plant. According to some embodiments, the size (e.g., the diameter) of the Crown 220 may be determined by the number of Facets 250 utilized. For example, the more Facets 250 of the Crown 220 used, the larger the Crown 220 will be, and the less Facets 250 used the smaller the Crown 220 will be. According to some embodiments, the size of the Crown 220 is dependent on the size of the plant (e.g., the size of the plant's canopy) to be supported by the Plant Support and Growth Directing Apparatus 200. Accordingly, in various embodiments, the Plant Support and Growth Directing Apparatus 200 is easily adjustable and modifiable to support various shapes and sizes of plants by adding or removing the number of Facets 250 of the Crown 220.

According to some embodiments, the Facets 250 may be connected to each other in any suitable manner such that they are stable, yet also are easily detachable for modifying the size of the Crown, such methods of attaching the Facets 250 to each other include, but are not limited to, adhesive, tying, Velcro®, bolting, using a spacer (e.g., a beaded wire), and/or the like. According to some embodiments, each Facet 250 may be adjustably rotatable around each Post (e.g., each Facet 250 may be capable of rotating or pivoting around the axis defined by the length of the Post 210). In further embodiments, the height of the Facet 250 along the Post may be adjustable along the length of the Post 210. Accordingly, in some embodiments, each Facet 250 may be removably attached to a Post 210 such that the Facet 250 may be adjustable around and/or along the Post 210. In such embodiments, the Facet 250 may be attached to the Post 210 in any suitable manner to allow for adjustment of the Facet 250, such as, but not limited to, by a releasable clamp, a releasable screw or bolt, a clip, and/or the like.

According to various embodiments, as few as two Facets 250 may be utilized in containing and supporting relatively small plants, and any suitable number of Facets 250 may be added to support larger sized plants. In particular embodiments, about three to about five Facets 250 may be used to support the Cannabis indica plant. In other embodiments, about four to eight Facets 250 may be used to support the Cannabis sativa plant.

According to various embodiments, each of the Facets 250 of the Crown 220 may include an Interior Trellis 252. The shape of the Facet's Interior Trellis 252 (e.g., the shape of the individual openings or frames of the Interior Trellis 252) may be any suitable shape for receiving and directing branches of a supported plant within the Plant Support and Growth Directing Apparatus 200, such as, but not limited to, rectangular, triangular, other polyhedrons, combinations thereof, and/or the like.

In a preferred embodiment the plant contact surface of the material comprising the Crown 220 is covered with an Abrasive Surface 260 as depicted in FIG. 2C thereby more effectively holding a portion of a Plant 14 in a user desired position when placed there by a user. Also the Abrasive Surface 260 permits a user to controllably abrade the Plant 14 thereby stressing the plant to stimulate a desired growth response. The Crown 120 depicted in FIG. 1 similarly may be comprised of an abrasive surface to more effectively hold and abrade or stress a plant.

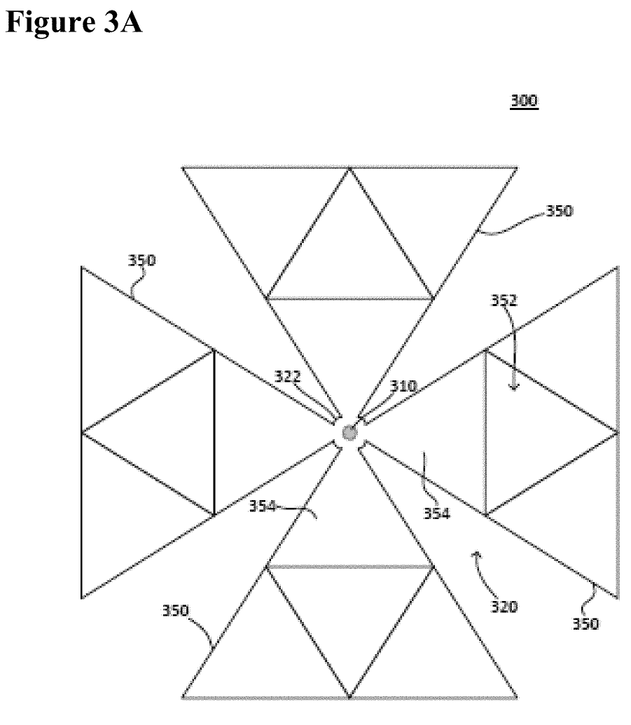

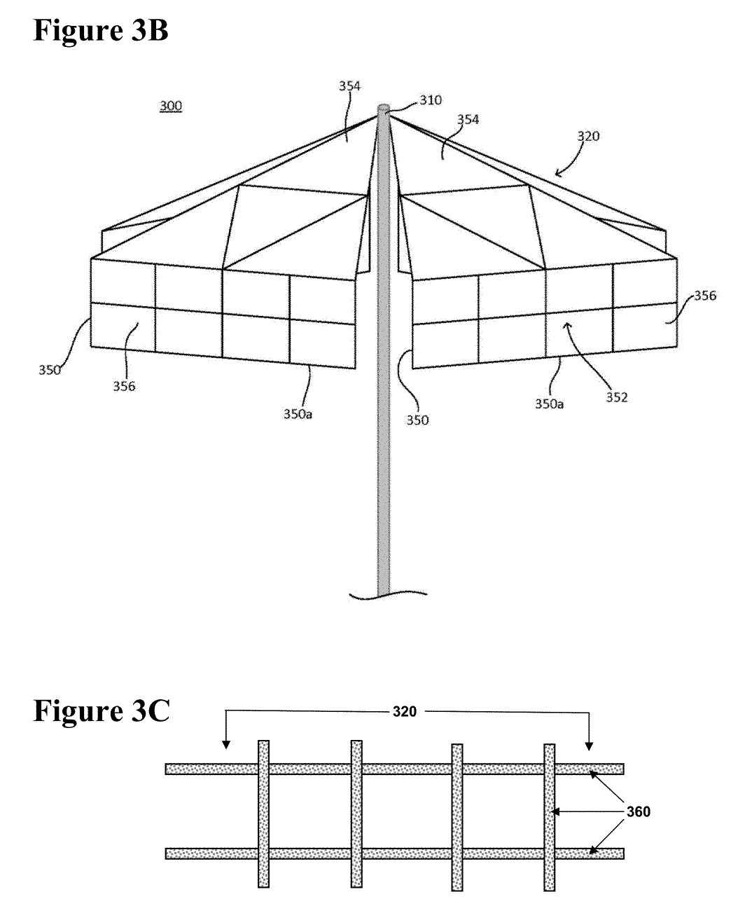

FIG. 3A depicts a top view of a combination rectangular and triangular patterned component post and crown embodiment of a Plant Support and Growth Directing Apparatus according to various embodiments.

FIG. 3B depicts a perspective view of the Plant Support and Growth Directing Apparatus shown in FIG. 3A.

FIG. 3C depicts a cutaway view of a portion of the Plant Support and Growth Directing Apparatus shown in FIG. 3A and FIG. 3B showing the abrasive surface disposed thereon.

Referring to FIGS. 3A and 3B, a Plant Support and Growth Directing Apparatus 300 includes a Post 310, and a Crown 320 including at least one Facet 350, each Facet 350 including an Interior Trellis 352. The Facet 350 may have a Top Portion 354 extending from the pole 310 and a downward portion 356 extending downward from the Top Portion 354. In some embodiments, the Post 310 may be rooted into the soil proximate the stalk of the plant, such as, but not limited to, about one to about two inches from the stalk of the supported plant. The Post 310 may be similar to the Post 110 or 210. In some embodiments, once a desired height of the Post 310 is achieved (e.g., by rooting a predetermined length of the Post 310 into the ground or by adding or removing extensions of the Post 310), the Crown 320 may be placed over the Post 310 and secured to the Post 310 at the Hole 322 of the Crown 320. In further embodiments, the Crown 320 may be adjustable along and/or around the Post 310 in similar manners as those described above with respect to the Post 210. In particular embodiments, the Crown 320 may have a wing shape (e.g., each of the Facets 350 is a wing). In some embodiments, the Crown 320 includes an even number of wings (e.g., two or four separate wings) so that the Crown 320 may be balanced when coupled to the Post 310. In further embodiments, each of the wings (e.g., the Facets 350) is equally spaced from each other and has a substantially similar size and weight as each of the other wings. In yet further embodiments, the wings or Facets 350 may be tethered to the Post 310 from the Bottom Edge 350a of the Facets 350 in addition to, or instead of, being clasped to the pole at the center of the Crown 320.

In some embodiments, the Crown 320 may be attachable to the Post 310 similar to how the Crown 120 or 220 is connectable to the Post 110 or 210. In various embodiments, the Crown 320 is a continuous piece (e.g., all four wings are manufactured to be a continuous component including a hole in the center of the Crown 320 so that the Post 310 may be inserted therethrough). In other embodiments, each wing is a separate component to be coupled to the Post 310, or opposite wings (e.g., wings that are directly across from each other over the Post 310) may be a continuous component (e.g., four wings may be manufactured as two separate continuous pieces). In some embodiments, a plant may be grown underneath the Crown 320 and the canopy of the plant may be woven into the Interior Trellises 352 of each wing or Facet 350. In particular embodiments, the Interior Trellis 352 may be located at the Downward Portion 356 of the Facet 350 such that branches may be woven into the Interior Trellis 352 horizontally outward from the apical meristem of the plant. In further embodiments, the Facet 350 also includes the Interior Trellis 352 at the Top Portion 354 of the Facet 350 such that the branches of the plant may also be woven vertically above the plant. In such embodiments, the Plant Support and Growth Directing Apparatus 200 allows more flexibility in directing the growth of the plant by a user.

In a preferred embodiment the plant contact surface of the material comprising the Crown 320 is covered with an Abrasive Surface 360 as depicted in FIG. 3C thereby more effectively holding a portion of a plant in a user desired position when placed there by a user. Also the Abrasive Surface 360 permits a user to controllably abrade the plant thereby stressing the plant to stimulate a desired growth response.

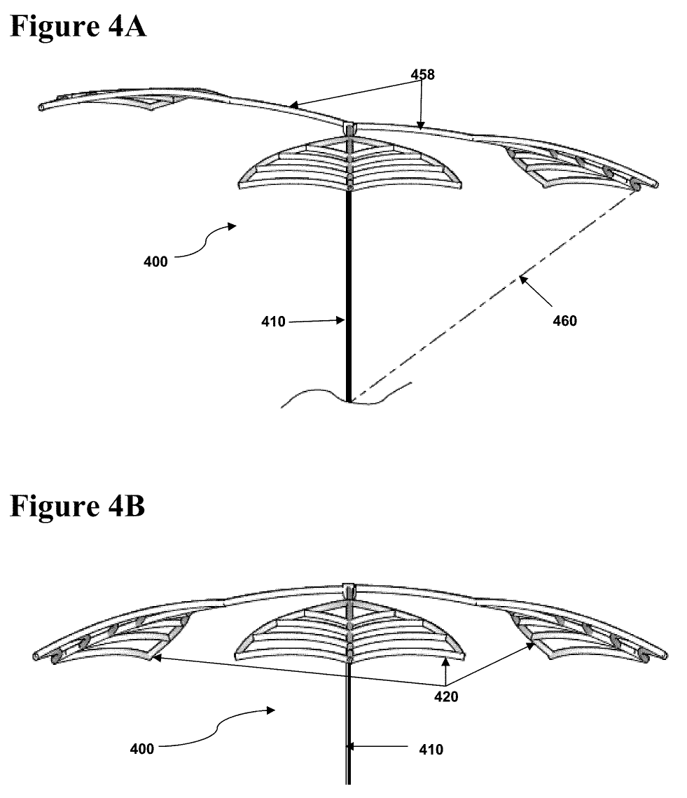

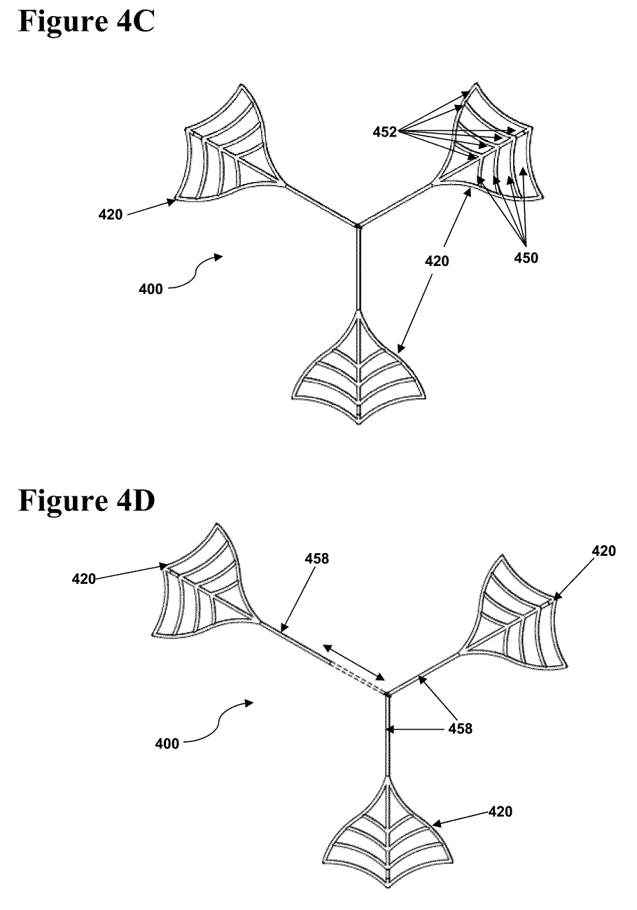

FIG. 4A depicts a side view of a wing shaped component post and crown embodiment of a Plant Support and Growth Directing Apparatus tethered to a post.

FIG. 4B depicts a side view of the Plant Support and Growth Directing Apparatus shown in FIG. 4A in an untethered condition.

FIG. 4C depicts a top view of the Plant Support and Growth Directing Apparatus shown in FIG. 4B.

FIG. 4D depicts a top view of the Plant Support and Growth Directing Apparatus shown in FIG. 4A showing the detachability of the apparatus' component parts.

Referring to FIG. 4, a Plant Support and Growth Directing Apparatus 400 includes a Post 410, a Crown 420, and a Tether 460. The Post 410 may correspond to the Posts 110 or 210. In some embodiments, the Crown 420 includes one or more Facets 450 including an Interior Trellis 452. The individual Facets 450 may be discreet and separate portions of the Crown 420 (e.g., similar to the wings shown in FIGS. 3A and 3B). In particular embodiments, the Crown 420 may include any suitable number of Facets 420 for adequately surrounding and supporting a canopy of a plant (e.g., one, two, three, four or more individual Facets).

In some embodiments, where individual Facets, bent-metal constructs, or waves do not touch each other (e.g., where the Crown 120 is not a continuous structure surrounding a plant), spacers may be utilized to couple the individual non-continuous components together (e.g., these non-continuous components may be tethered together horizontally such that the connecting spacer crosses the Post 110 perpendicularly). In other words, each of the Facets 450 may be coupled to a neighboring Facet 450 by a spacer. The connecting spacers may provide greater stability to the Crown 420. Plant Support and Growth Directing Apparatus 300 shown in FIGS. 3A-3B may also utilize spacers. In further embodiments, the spacer may be made from any suitable material, such as, but not limited to, flexible metal wiring, rubber, string, or the like, and combinations thereof. In yet further embodiments, the spacer may further include metal beads.

In various embodiments, the Crown 420 (or any Crown described herein) may be made from any suitable material capable of securing branches of a plant supported by the Plant Support and Growth Directing Apparatus 400 but flexible enough for allowing adaptability of the Plant Support and Growth Directing Apparatus 400 to function with different sized and shaped plants. For example, the Crown 420 (e.g., the Interior Trellis 452) may be made from a material such as, but not limited to, a semi-rigid wire, which may be suitably sturdy yet flexible enough to be bent about 10 degrees to about 20 degrees in any desired direction.

According to various embodiments, the Plant Support and Growth Directing Apparatus 400 also include the Tether 460 coupling the Facets 450 to the Post 410 for further stabilization and adjustability of the Facets 450 of the Crown 420. In some embodiments, individual Tethers 460 may be coupled to respective Facets 450, such that each Facet 450 is independently tied to the Post 410. In some embodiments, all of the Facets 450 are coupled to the Post 410 via the Tether 460. In other embodiments, some, but not all, of the Facets 450 are coupled to the Post 410 via the Tether 460. In various embodiments, the Tether 460 is coupled to the Facet 450 by any suitable method for securing the Facet 450 to the Post 410, such as, but not limited to, tying, plugging, bolting, using adhesive, or the like.

According to various embodiments, the Tether 460 may be adjusted to allow for a desired amount of slack in the Tether 460 to adjust the proximity of the Facet 450 to the Post 410. For example, if a plant has a smaller canopy, a user may increase the tension in the Tether 460 to draw the Facet 450 closer to the Post 410 so that the Facet 450 is closer to the branches of the canopy of the plant, and vice versa for plants having larger canopies. In some embodiments, the Tether 460 is tied to the Facet 450 at a central location of the Facet 450 and at a bottom of the Facet 450. In other embodiments, the Tether 460 is coupled to the Facet 450 at a middle of the Facet (e.g., at the Interior Trellis 452). In various embodiments, the Tether 460 may be made from any suitable material, such as, but not limited to, flexible metal wiring, rubber, string, or the like, and combinations thereof. In yet further embodiments, the Tether 460 may further include metal beads.

In further embodiments, the Crown 420 may include an Arm 458 that attaches to the Post 410 and connects the Post to each of the Facets 450. In some embodiments, the Arm 458 is permanently attached to the Post 410 and/or the Facet 450, for example, but not limited to, by welding, by adhesive, by bolting, or the like. In other embodiments, the Arm 458 is removably attached to the Post 410 and/or the Facet 450, for example, but not limited to, by adhesive, by male and female plugs, by screws, or the like. According to some embodiments, the Arm 458 is made from a material that is sturdy enough to support the Facet 452 but flexible enough to allow adjustment of the proximity the Facet 450 to the Post 410 via the Tether 460, such as, but not limited to, plastic, rubber, metal, the like, or combinations thereof.

Referring to FIG. 4D depicts a top view of the Plant Support and Growth Directing Apparatus shown in FIG. 4A showing the detachability of the Crown 420.

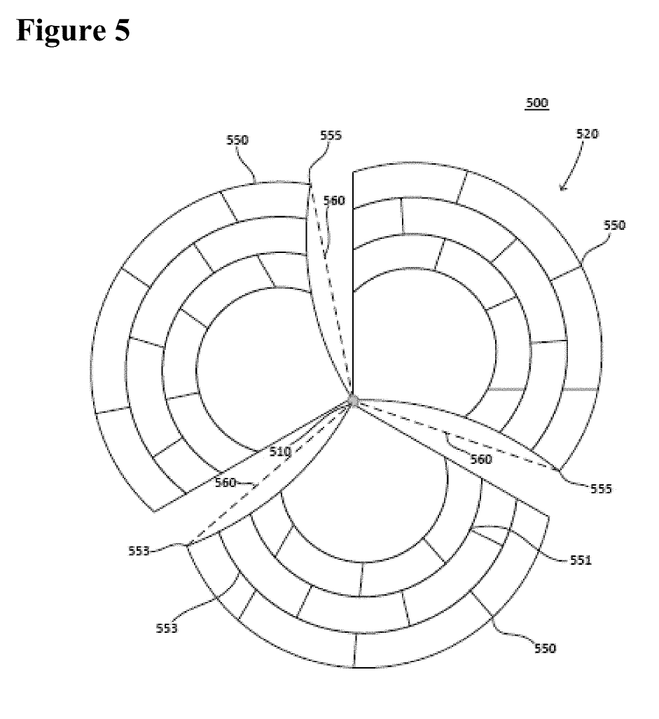

FIG. 5 depicts a top view of a fan shaped lattice component post and crown embodiment of a Plant Support and Growth Directing Apparatus including a tether to the post.

Referring to FIG. 5, a Plant Support and Growth Directing Apparatus 500 includes a Post 510, a Crown 520, and Tethers 560. The Post 510 may correspond to the Post 110 or 210, and the Tethers 560 may correspond to the Tether 460. In addition, the Crown 520 may correspond to the Crown 420, except for the shape of the Facets 550. In some embodiments, the Facets 550 are an irregular shape that includes an enlarged portion 551 and a thin portion 553. In other words, the Crown 520 may take on the shape of an aircraft propeller. In other embodiments, the Facets 550 of the Crown 520 may take on any suitable regular or irregular shape for adequately encompassing a plant and providing support to the plant, such as, but not limited to, rectangles, triangles, any other polygon, and combinations thereof. In some embodiments, because of the irregular design of the Facets 550 of the Crown 520, each of the Facets may be heavier at certain portions than at others, for example, the Facet 550 at the Enlarged Portion 551 may be heavier than at the Thin Portion 553. Accordingly, in particular embodiments, the Tethers 560 may be coupled to each of the Facets 550 at a non-central location of the Facet 550 to accommodate the irregular weight of the Facet 550, for example, the Tether 560 may be coupled at a Connection Location 555 at a side edge of the Facet 550. In some embodiments, the Facet 550 may have a descending elevation such that the Facet 550 is directed toward the ground along the edge of the Facet 550, to more fully encompass a canopy of a plant.

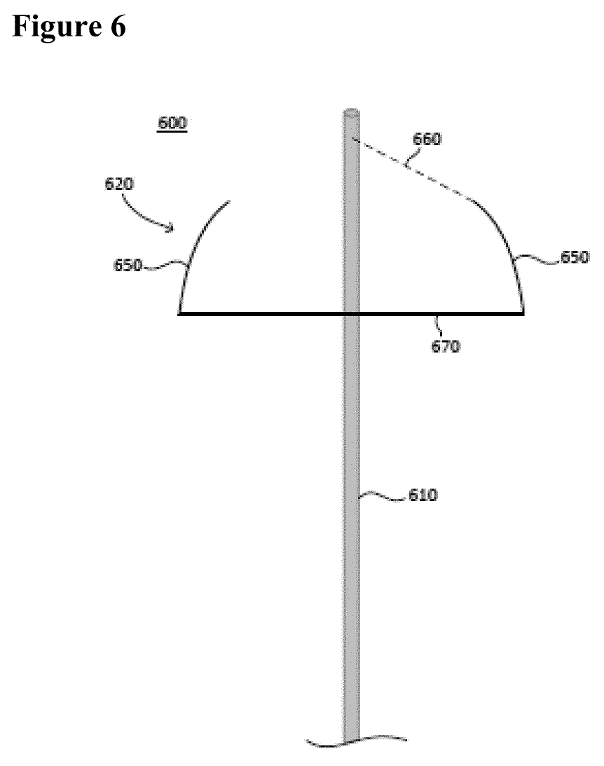

FIG. 6 depicts a perspective view of a Plant Support and Growth Directing Apparatus with a upward tethering and arm support system.

Referring to FIG. 6, a Plant Support and Growth Directing Apparatus 600 includes a Post 610, a Crown 620 having at least one Facet 650, Tethers 660, and a Support 670. The Post 610 may correspond to the Post 110 or 210, the Tethers 660 may correspond to the Tether 460, and the Facet 650 may correspond to any of the Facets previously discussed. In some embodiments, the Support 670 may be a rigid structure that horizontally traverses the bottom of a canopy of a supported plant. In some embodiments, the Support 660 is permanently attached to the Post 610, for example, but not limited to, by welding, by adhesive, by bolting, and the like. In other embodiments, the Support 670 is removably attached to the Post 610, for example, but not limited to, by adhesive, by male and female plugs, by screws, and the like. In particular embodiments, the Support 670 is adjustable along the Post 610. For example, the height of the Support 670 along the Post 610 or the orientation of the Support 670 around the Post 610 (rotatably) may be adjustable. In some embodiments, the Crown 620 may include a plurality of Supports 670. According to various embodiments, the Support 670 may be made from any suitable rigid material, such as, but not limited to, wood, metal, plastic, the like, or combinations thereof.

In various embodiments, the Facets 650 having interior trellises may project upwards toward the top of the Post 610 from the Support 670. The Facets 650 may correspond to any of the Facets disclosed herein. In addition, the Facets 650 may be further supported by the Tether 660 coupled between the Facet 650 and the Post 610. According to various embodiments, the Plant Support and Growth Directing Apparatus 600 allows further support to a plant by including the Support 670 underneath a canopy of a supported plant, in addition to the Facets 650.

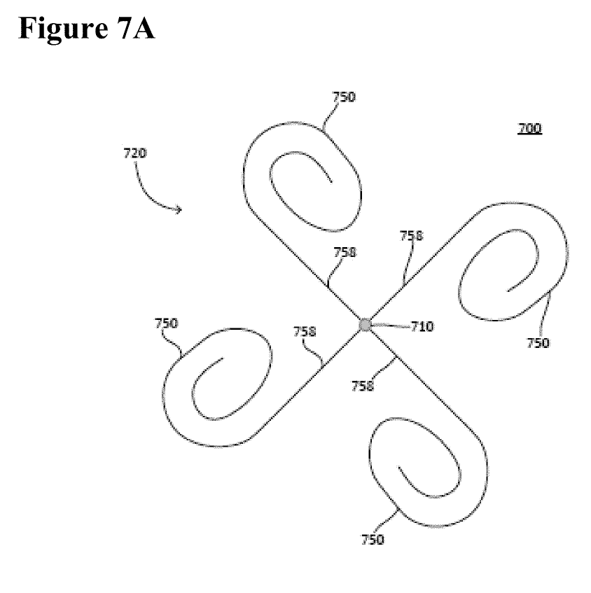

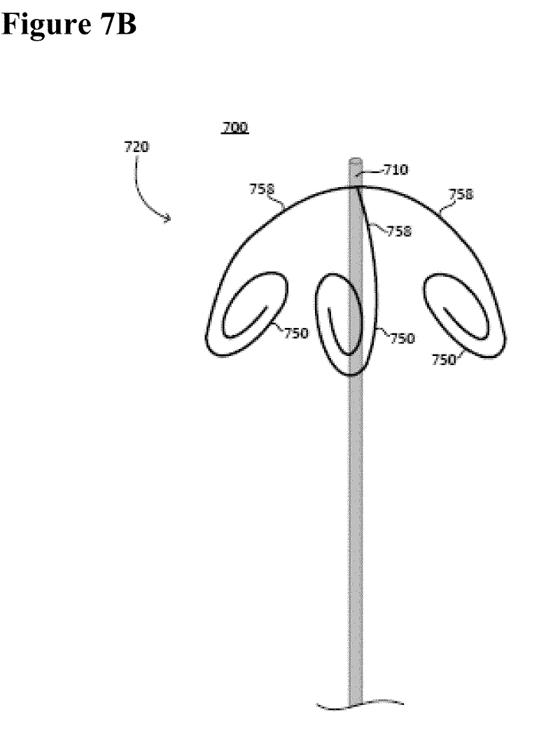

FIG. 7A depicts a top view of a tight coil component post and crown embodiment of a Plant Support and Growth Directing Apparatus.

FIG. 7B depicts a perspective view of the Plant Support and Growth Directing Apparatus shown in FIG. 7A.

Referring to FIGS. 7A and 7B, a Plant Support and Growth Directing Apparatus 700 includes a Post 710 and a Crown 720 having one or more Facets 750. The Post 710 may correspond to the Post 110 or 210 and the Crown 720 may correspond to the Crown 620. In some embodiments, the Crown 720 may include Arm s 758 coupled between the Facets 750 and the Post 710. The Arms 758 may correspond to the Arms 458. In particular embodiments, the Facets 750 may be a structure that is wound around itself to form an arced spiral structure. In such embodiments, the branches of a plant may we woven within the arced spiral structure of the Facet 750. In some embodiments, the entire Crown 720 is made from a same material, such as, but not limited to metal, plastic, wire, combinations thereof, or the like. In other embodiments, the Arm 758 is made of a different material from that of the Facets 750. In particular embodiments, the Crown 720 is made of one continuous piece of material.

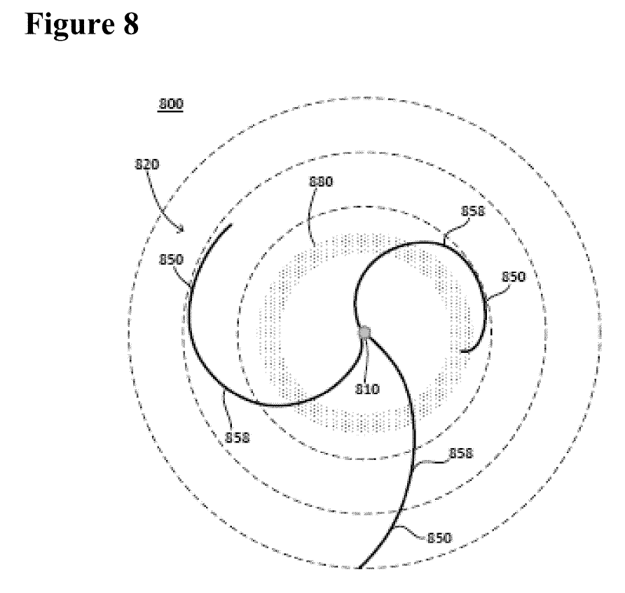

FIG. 8 depicts a top view of a relaxed coil or whip component post and crown embodiment of a Plant Support and Growth Directing Apparatus.

Referring to FIG. 8, a Plant Support and Growth Directing Apparatus 800 includes a Post 810 and a Crown 820. The Post 810 may correspond to the Post 110 or 210 and the Crown 820 may correspond to the Crown 620. In some embodiments, the Crown 820 includes one or more Arms 858. The Arms 858 may correspond to the Arms 758. In particular embodiments, the Arms 858 constitute a framework or skeleton that is configured to surround a canopy of a supported plant. According to various embodiments, the Arms 858 may be rigid and be manufactured at different lengths to encompass various sizes of plants. In other embodiments, the Arms 858 are bendable such that they are capable of being adjusted by a user to encompass various sizes of plants, for example, each of the Arms 858 may include a plurality of joints or hinges along the length of the Arm 858 for adjustability. In additional embodiments, the Plant Support and Growth Directing Apparatus 800 includes a single Post 810 at the center at a location where each of the Arms 858 meet. In other embodiments, the Plant Support and Growth Directing Apparatus 800 includes a plurality of Posts 810, each Post 810 being coupled to a respective Arm 858 at an outer perimeter of the Plant Support and Growth Directing Apparatus 800 such that the Posts 810 surround a supported plant. In various embodiments, the Crown 820 further includes Chainmail 880 that may be placed on (e.g., wrapped around) the frame comprised of the Arms 858. The Chainmail 880 may be a prefabricated, flexible strip that may be wound around the framework of Arms 858 that encompass the canopy of the plant, thus creating the Crown 820. The Chainmail 880 may be made of any suitable material for receiving and securing branches of the plant, such as, but not limited to, metal wire, rubberized plastic, a natural material such as hemp cord, and/or the like. In some embodiments, the Chainmail 880 may be manufactured in lengths (e.g., custom cut) or in a spool to be cut by a user. According to various embodiments, the Chainmail 880 wraps around the frame of Arms 858 around the perimeter of the canopy. In further embodiments, the Chainmail 880 may be affixed to the Arms 858 using an affixing aid, such as, but not limited to, adhesive, clamps, nails, combinations thereof, and/or the like. In some embodiments, the Chainmail 880 may be coated with an anti-slip coating to minimize the possibility of the Chainmail 880 slipping off of the Arms 858 and possibly damaging a supported plant. In particular embodiments, the branches of a plant that is woven through the Chainmail 880 may also provide resistance to the Chainmail 880 from slipping down the Arms 858. In some embodiments, the Arms 858 may include notches, bumps, or ridges along their lengths to provide resistance to the Chainmail from sliding down the Arms 858. The Chainmail 880 may include an interior trellis similar to the Interior Trellises 252, 352, 452 discussed above for receiving and securing branches of the plant.

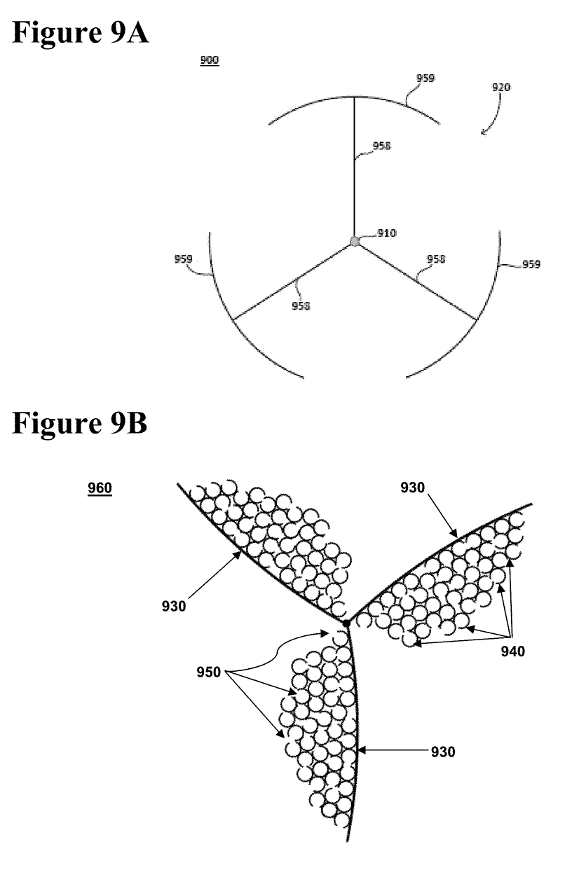

FIG. 9A depicts a top view of a curved top T-shaped component post and crown embodiment of a Plant Support and Growth Directing Apparatus.

FIG. 9B depicts a top view of a notched open circle component post and crown embodiment of a Plant Support and Growth Directing Apparatus.

Referring to FIG. 9A, a Plant Support and Growth Directing Apparatus 900 includes a Post 910 and a Crown 920. The Post 910 may correspond to the Post 110 or 210 and the Crown 920 may correspond to the Crown 820. In some embodiments, the Crown 920 having the framework capable of holding the chainmail includes Arms 958 and Walls 959 coupled to the Arms 958. According to some embodiments, the Walls 959 allow the flexibility to drape chainmail over the framework such that the chainmail hangs parallel to the apical meristem of a supported plant, providing more locations of support for branches of the plant. Accordingly, the Crown 920 may be positioned higher on the Post 910 above the canopy of the plant so that the chainmail draped over the Crown 920 falls to the canopy.

Referring to FIG. 9A, a notched open circle component post and crown embodiment Plant Support and Growth Directing Apparatus 960 includes at least one Support Arm 930 attached to which are a multiplicity of Open Circle Members 940 the assembly of which may be attached to the Post 910 and a Crown 920 in lieu of or in addition to the Crown 920. Each Open Circle Member 940 having a Plant Receiving Opening 950 capable of permitting a user to place a portion of a plant therein and thereby retaining a Plant 14 in a user selected position.

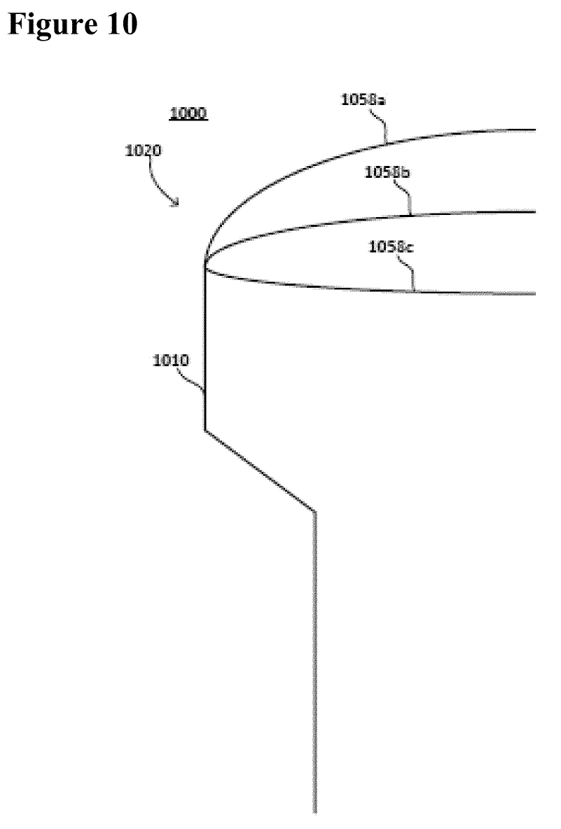

FIG. 10 depicts a side view of a cantilevered support post and crown embodiment of a Plant Support and Growth Directing Apparatus according to various embodiments.

Referring to FIG. 10, a Plant Support and Growth Directing Apparatus 1000 includes a Post 1010 and a Crown 1020. The Post 1010 may correspond to the Post 110 or 210 (e.g., the Plant Support and Growth Directing Apparatus 1000 may include a plurality of angled Posts 1010 with a plurality of Crowns 1020 surrounding a supported plant). The Crown 1020 may include a plurality of Arms 1058a, 1058b, 1058c. In other embodiments, the Crown 1020 may include any suitable number of arms for adequately retaining a Chainmail over a canopy of a plant (e.g., one, two, four, or more arms). In some embodiments, the Arms 1058a, 1058b, 1058c may surround a canopy of a plant, with Arm 1058a being on top of the canopy and Arms 1058b, 1058c being at sides of the canopy. Accordingly, a chainmail may be draped over the claw-like structure of the Crown 1020 to encompass the canopy of the supported plant. In further embodiments, any suitable number of Plant Support and Growth Directing Apparatuses 1000 may be used to surround a plant and provide support to the plant, depending on type and size of the plant.

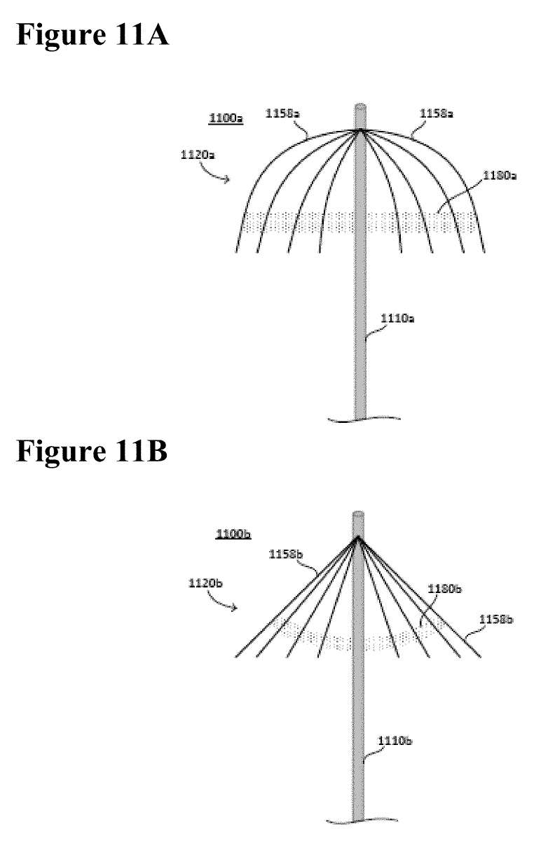

FIG. 11A depicts a side view of a rounded umbrella shaped component post and crown embodiment of a Plant Support and Growth Directing Apparatus utilizing chainmail.

FIG. 11B depicts a side view of a straight umbrella shaped component post and crown embodiment of a Plant Support and Growth Directing Apparatus utilizing chainmail.

Referring to FIG. 11A, a Plant Support and Growth Directing Apparatus 1100a includes a Post 1110a and a Crown 1120a. The Post 1110a may correspond to the Post 110 or 210 and any other post disclosed herein, and the Crown 1120a may correspond to the Crown 820 or any other crown disclosed herein. The Crown 1120a may include Arms 1158a and Chainmail 1180a. The Arms 1158a may correspond to Arms 858 and the Chainmail 1180a may correspond to Chainmail 880. According to some embodiments, the Arms 1158a provide a downward arching dome-like framework around which the Chainmail 1180a may be wrapped for providing support to a plant.

Referring to FIG. 11B, a Plant Support and Growth Directing Apparatus 1100b includes a Post 1110b and a Crown 1120b. The Post 1110b may correspond to the Post 110 or any other Post disclosed herein, and the Crown 1120a may correspond to the Crown 820 or any other Crown disclosed herein. The Crown 1120b may include Arms 1158b and Chainmail 1180b. The Arms 1158b may correspond to Arms 858 and the Chainmail 1180b may correspond to Chainmail 880. According to some embodiments, the Arms 1158b provide a straight downward projecting framework around which the Chainmail 1180b may be wrapped for providing support to a plant. In such embodiments, the Chainmail 1180b may be affixed to the Arms 1158b without the aid of any additional element (e.g., adhesive, etc.) in embodiments where the angle of downward projection of the Arms 1158b is not overly steep.

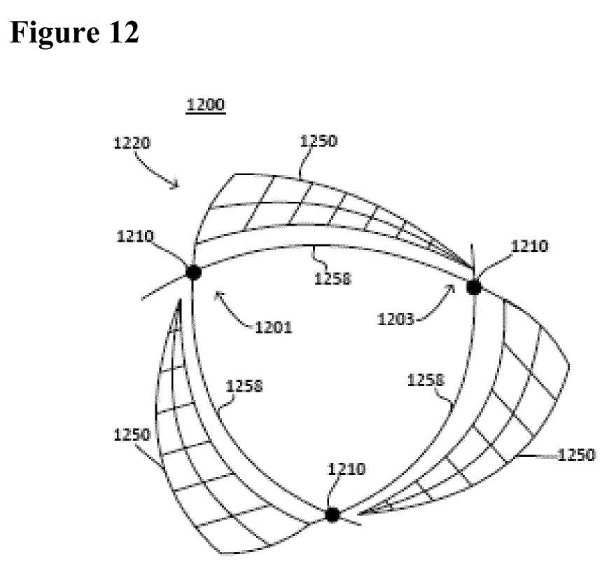

FIG. 12 depicts a top view of a cantilevered sail shaped lattice component post and crown embodiment of a Plant Support and Growth Directing Apparatus.

Referring to FIG. 12, the Plant Support and Growth Directing Apparatus 1200 includes a plurality of Posts 1210 and a Crown 1220 having a plurality of Arms 1258 coupled to respective Facets 1250. The Posts 1210 may correspond to the Post 110 or the Post 210. The Crown 1220 may correspond to the Crown 520. The Facets 1250 may correspond to the Facets 550. The Arms 1258 may correspond to the Arms 758. According to some embodiments, each Arm 1258 is attached to two neighboring Posts 1210, thus creating a triangular structure in which a plant may be supported. Each Arm 1258 may have a Facet 1250 coupled to one of the ends of the Arm 1258 (e.g., at Arm end 1201), for example, at a location of one of the Posts 1210. In some embodiments, the opposite end of the Arm 1258 (e.g., the end of the Arm 1258 not connected to the Facet or Arm end 1203) may be attached to the neighboring Post 1210 at a location slightly lower along the length of the neighboring Post 1210 than where the Facet 1250 is attached to the Arm at the opposing end of the Arm 1258. Thus, according to some embodiments, the Crown 1220 may exhibit a spiraling effect of the Facets 1250 around the length of the supported plant. According to particular embodiments, any suitable number of Posts 1210, Facets 1250, and/or Arms 1258 may be used in the Plant Support and Growth Directing Apparatus 1200 (e.g., two, four, or more sets of posts, arms, and facets).

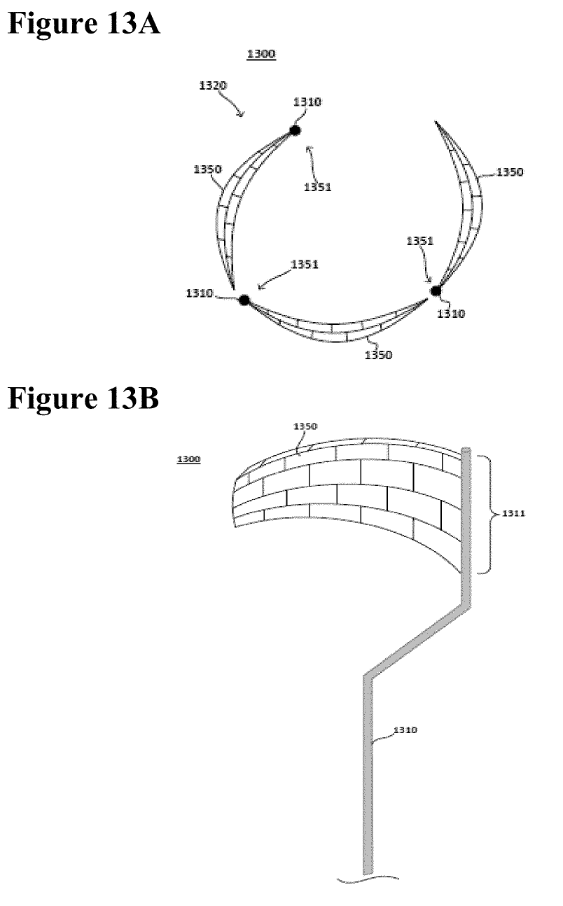

FIG. 13A depicts a top view of a cantilevered flag shaped lattice component post and crown embodiment of a Plant Support and Growth Directing Apparatus according to various embodiments.

FIG. 13B depicts a perspective view of the Plant Support and Growth Directing Apparatus shown in FIG. 13A.

Referring to FIGS. 13A and 13B, the Plant Support and Growth Directing Apparatus 1300 includes a plurality of Posts 1310 and a Crown 1320 including a plurality of outwardly arcing Facets 1350. The Posts 1310 may correspond to the Post 110 or the Post 210. The Facets 1350 may correspond to the Facets 550. According to some embodiments, each Facet 1350 is attached to a respective Post 1310, thus creating a circular structure in which a plant may be supported. Each Post 1310 may be coupled to one of the ends of the Facet 1350 (e.g., at Facet End 1351). In some embodiments, a predetermined length of the Post 1310 may include a Rotatable Portion 1311. In particular embodiments, the Rotatable Portion 1311 corresponds to the location at which the Facet 1350 is coupled to the Post 1310. The Rotatable Portion 1311 may be configured to swivel with respect to the stationary remainder of the Post 1310. Accordingly, in some embodiments, the Facet 1350 is capable of outwardly or inwardly swinging, which provides greater adjustability of the Plant Support and Growth Directing Apparatus 1300 for supporting plants of various types and sizes. According to some embodiments, the Rotatable Portion 1311 may rotate 360 degrees (or less) about the axis of the Post 1310 that is along the length of the Post 1310. In some embodiments, the Rotatable Portion 1311 is coupled to the remainder of the Post 1310 in any suitable manner to allow free rotational movement of the Facet 1350, such as, but not limited to, by a ball and socket or a hinge mechanism.

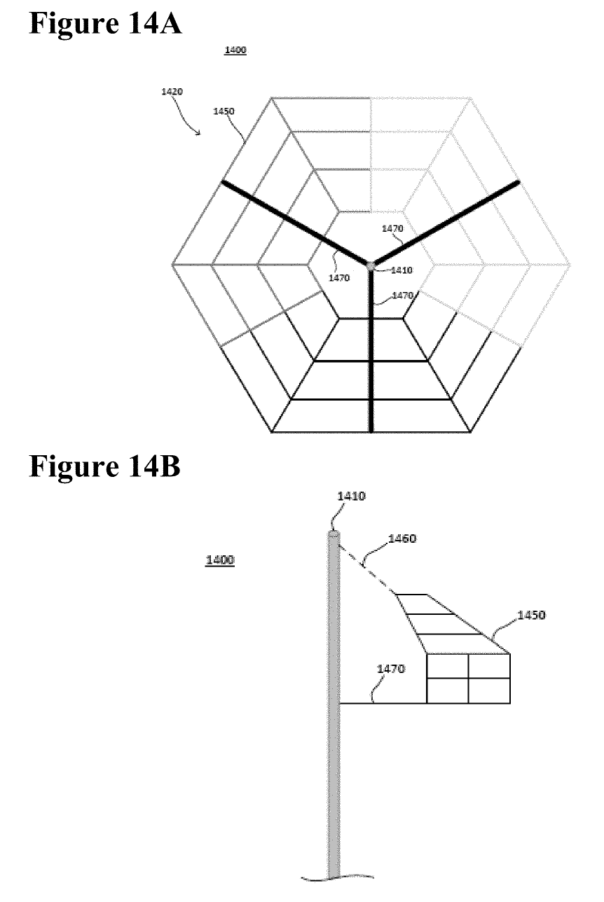

FIG. 14A depicts a top view of a pyramid shaped lattice post and crown embodiment of a Plant Support and Growth Directing Apparatus.

FIG. 14B depicts a perspective view of the Plant Support and Growth Directing Apparatus shown in FIG. 14A.

Referring to FIGS. 14A and 14B, the Plant Support and Growth Directing Apparatus 1400 includes a Post 1410, a Crown 1420 including a plurality of Facets 1450, and one or more Arms 1470 supporting the Facets 1450. The Post 1410 may correspond to the Post 610. The Facets 1450 may correspond to the Facets 650. The one or more Arms 1470 may correspond to the Arms 670. In further embodiments, the Facets 1450 may also be supported by at least one Tether 1460 (which may correspond to the Tether 660). In some embodiments, the Facets 1450 that are supported by the Arms 1470 may have a pyramid shape that is wide at the bottom of the Facet 1450 and narrower along the height of the Facet 1450 (towards the top of the post). Accordingly, in some embodiments, the Facet 1450 may be structurally tailored to encompass a canopy of a plant by substantially following the shape of a canopy.

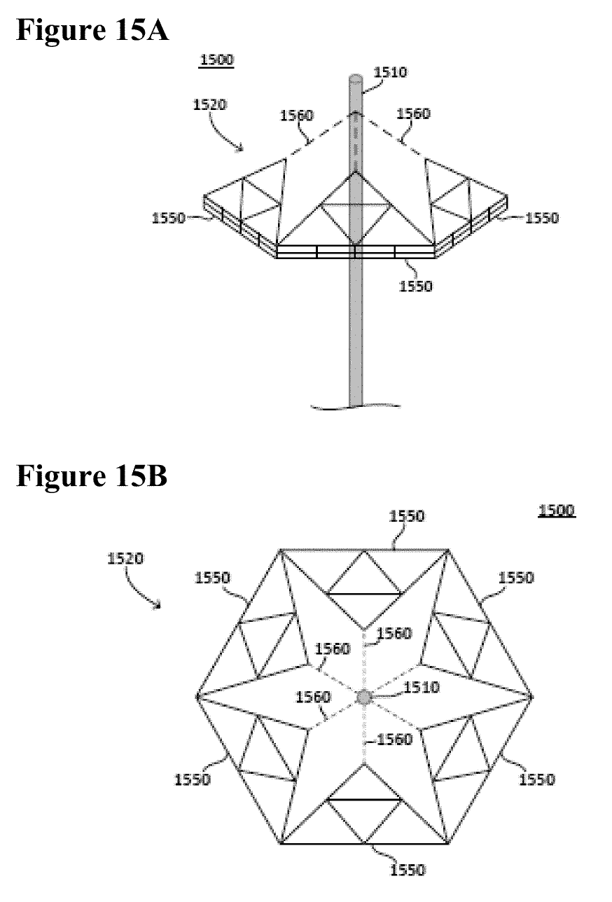

FIG. 15A depicts a perspective view of a star shaped lattice post and crown embodiment of a Plant Support and Growth Directing Apparatus.

FIG. 15B depicts a top view of the Plant Support and Growth Directing Apparatus shown in FIG. 15A.

Referring to FIGS. 15A and 15B, the Plant Support and Growth Directing Apparatus 1500 includes a Post 1510, a Crown 1520 including a plurality of Facets 1550, and one or more Tethers 1560 supporting the Facets 1550. The Post 1510 may correspond to the Post 110 or 210. The Facets 1550 may correspond to the Facets 550. The Tethers 1560 may correspond to the Tethers 560. In some embodiments, the Facets 1550 have a triangular shape that is wide at the bottom of the Facet 1550 and narrower along the height of the Facet 1450 (towards the top of the pole) until the Facet 1550 ends with an edge point at which the Tether 1560 is coupled to the Facet 1550. Accordingly, in some embodiments, the Facet 1550 may be structurally tailored to encompass a canopy of a plant by substantially following the shape of a canopy, and be supported with minimal additional elements, as a single Tether 1560 may be connected to an edge point of the Facet 1550 to suitably secure the Facet 1550 to the Post 1510. In other embodiments, a plurality of Tethers 1560 may be coupled to each Facet 1550 for added support.

FIG. 16 depicts a top view of weaving stems of a plant through a Plant Support and Growth Directing Apparatus according to all of the disclosed embodiments.

Referring to FIG. 16, a Crown 1620 includes a plurality of Facets 1650 having Interior Trellises 1652. The Facets 1650 may correspond to Facets 250 and the Interior Trellises 1652 may correspond to the Interior Trellis 252. A plant supported by the Crown 1620 may include a plurality of Apical Branches 1602. According to some embodiments, the Apical Branches 1602 may be woven around the Crown 1620 in a cylindrical pattern. The Apical Branches 1602 may be woven twice or more through the Interior Trellis 1652 (e.g., in an over then under pattern, or an under then over pattern). Accordingly, the weaving of the Apical Branches 1602 through the Interior Trellises 1652 of the Facets 1650 may increase the surface area of the canopy by spreading the canopy over a wider area. Furthermore, the weaving may expose certain lower sites of the canopy that would otherwise be shielded from light, to the light, and may expose the lower sites to an ideal absorption horizon of light. In addition, the weaving of the Apical Branches 1602 through the Crown 1620 may create increased space between flowers to lessen the likelihood of occurrence of mold.

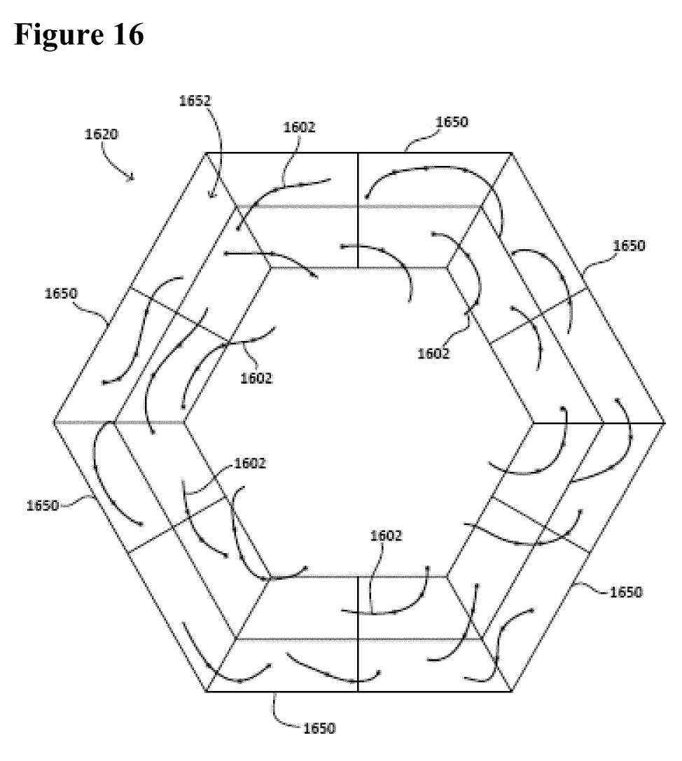

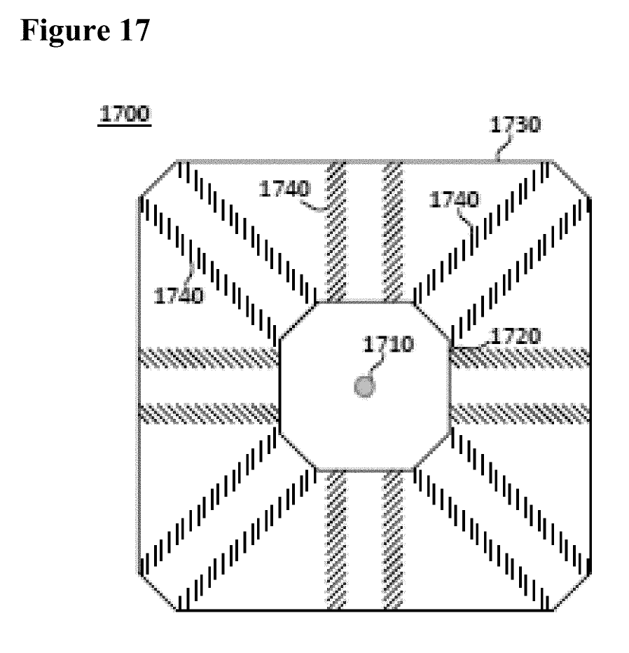

FIG. 17 depicts a top view of a spring component post and crown embodiment of a Plant Support and Growth Directing Apparatus.

Referring to FIG. 17, a Plant Support and Growth Directing Apparatus 1700 includes a Post 1710, an Internal Frame 1720, an External Frame 1730, and Springs 1740. According to some embodiments, the Internal Frame 1720 is coupled to and encompasses the Post 1710. The Internal Frame 1720 may be coupled to the Post 1710 via tethers, arms, combinations thereof, and/or the like. The External Frame 1730 may be coupled to the Internal Frame 1720 and/or the Post 1710, and may encompass both the Internal Frame 1720 and the Post 1710. In some embodiments, the External Frame 1730 may be coupled to the Internal Frame 1720 via the Springs 1740. The External Frame 1730 and the Internal Frame 1720 may be made from any suitable rigid material, such as, but not limited to, wood, plastic, wire, metal, composites thereof, and the like. In particular embodiments, the Internal Frame 1710 and the External Frame 1730 may be any suitable shape, such as, but not limited to, circular, triangular, rectangular, etc. In further embodiments, the Internal Frame 1720 and the External Frame 1730 are different shapes and/or made from different materials.

According to some embodiments, the Spring 1740 is coupled between the External Frame 1730 and the Internal Frame 1720. The Spring 1740 may have coils and be made from any suitable material, such as, but not limited to, metal, plastic, and the like. According to various embodiments, the branches of a supported plant may be woven into the coils of the Spring 1740, as desired, for directing and guiding the growth of a supported plant. This provides the ability to control a canopy's height for maximum light absorption. In some embodiments, branches of the plant may be bent over at a 90-degree angle (e.g., for high stress or low stress super cropping). In particular embodiments, each branch may be placed through two coils for extra security. In other embodiments, each branch may be woven through only one coil. In various embodiments, the Springs 1740 will give when disturbances are introduced to the plant (e.g., a fan blowing at the plant), and will thus provide slight movement and allow sap to continue flowing within the supported branches.

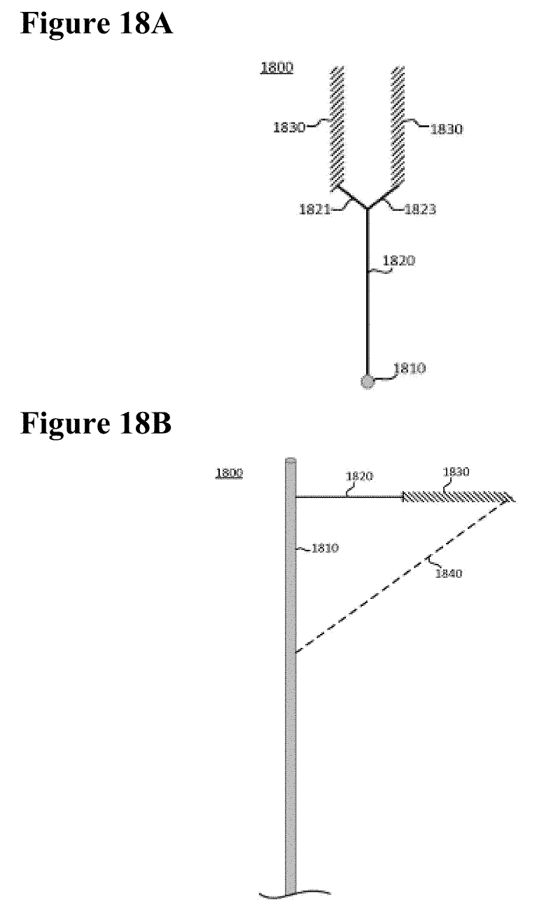

FIG. 18A depicts a top view of a cantilevered spring post and crown embodiment of a Plant Support and Growth Directing Apparatus.

FIG. 18B depicts a side view of the Plant Support and Growth Directing Apparatus shown in FIG. 18A tethered to a post.

Referring to FIGS. 18A and 18B, a Plant Support and Growth Directing Apparatus 1800 includes a Post 1810, an Arm 1820, Auxiliary Arms 1821 and 1823 branching outwards from the Arm 1820, Springs 1830 coupled to the Auxiliary Arms 1821 and 1823, and a Tether 1840 coupled to the Springs 1830. The Post 1810 may correspond to the Post 110 or 210, the Arm 1820 and Auxiliary Arms 1821 and 1823 may correspond to the Arms 670, and the Springs 1830 may correspond to the Spring 1740. According to various embodiments, the Arm 1820 outwardly projects from the Post 1810 and the Auxiliary Arms 1821, 1823 split off from the Arm 1820 in two separate directions. As such, according to some embodiments, the number of Springs 1830 coupled to the Auxiliary Arms 1821, 1823 correspond to the number of Auxiliary Arms 1821, 1823, as each Spring 1830 is coupled to a respective Auxiliary Arm 1821, 1823. In other embodiments, there may be more than two Auxiliary Arms 1821, 1823 corresponding to more than two Springs 1830 (e.g., three or more each of Auxiliary Arms 1821, 1823 and Springs 1830). In further embodiments, a Tether 1840 is coupled between one or more of the Springs 1830, the Auxiliary Arms 1821, 1823, or the Arm 1820 and the Post 1810. In some embodiments, there may be a plurality of Plant Support and Growth Directing Apparatuss 1800 surrounding a supported plant (e.g., four equidistant Plant Support and Growth Directing Apparatuss 1800 coupled to the Post 1810 and supporting a plant).

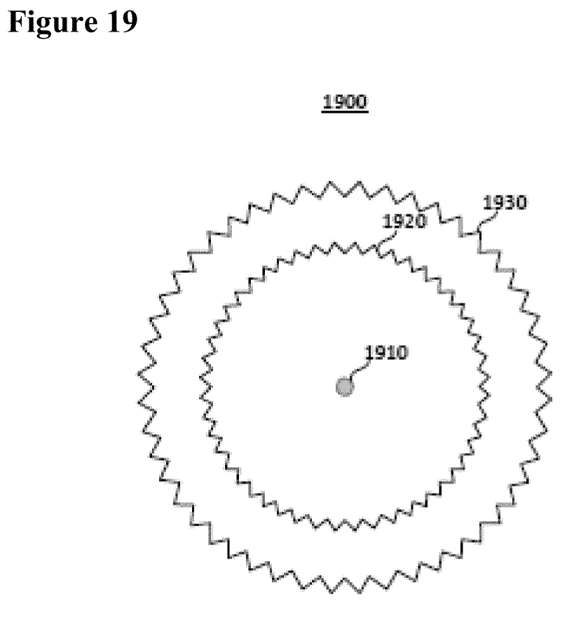

FIG. 19 depicts a top view of a saw blade pattern component post and crown embodiment of a Plant Support and Growth Directing Apparatus according to various embodiments.

Referring to FIG. 19, a Plant Support and Growth Directing Apparatus 1900 includes a Post 1910, an Inner Pattern 1920, and an Outer Pattern 1930. According to various embodiments, the Inner Pattern 1920 is coupled to and encompasses the Post 1910. The Inner Pattern 1920 may be coupled to the Post 1910 via tethers, arms, combinations thereof, and/or the like. The Outer Pattern 1930 may be coupled to the Inner Pattern 1920 and/or the Post 1910, and may encompass both the Inner Pattern 1920 and the Post 1910. In some embodiments, the Outer Pattern 1930 may be coupled to the Inner Pattern 1920. The Outer Pattern 1930 and the Inner Pattern 1920 may be made from any suitable rigid material, such as, but not limited to, wood, plastic, wire, metal, composites thereof, and the like. In particular embodiments, the Inner Pattern 1920 and the Outer Pattern 1930 may be any suitable shape, such as, but not limited to, circular, triangular, rectangular, etc. In further embodiments, the Inner Pattern 1920 and the Outer Pattern 1930 are different shapes and/or made from different materials. According to various embodiments, the Inner Pattern 1920 and the Outer Pattern 1930 may be a wire bent to have a zig-zag pattern (e.g., have a plurality of sharp angular points). According to various embodiments, branches of a supported plant may be woven between the Inner Pattern 1920 and the Outer Pattern 1930 and/or within the structure of the respective Inner Pattern 1920 and/or Outer Pattern 1930.

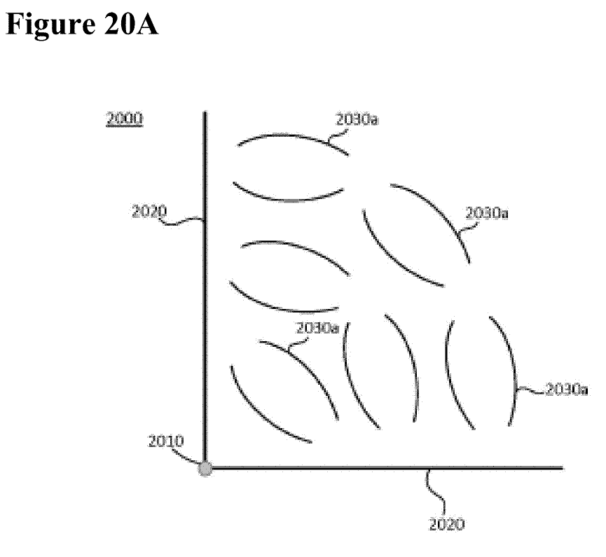

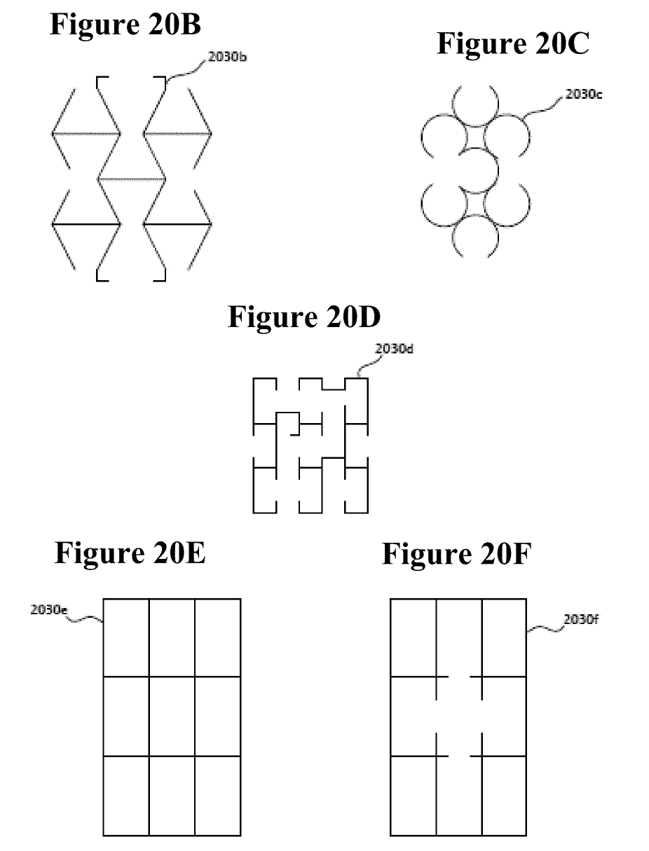

FIGS. 20A-20F depict top views of various shaped post and crown embodiments of a Plant Support and Growth Directing Apparatuses.

Referring to FIGS. 20A-20F, a Plant Support and Growth Directing Apparatus 2000 includes a Post 2010, Arms 2020, and a plurality of Tiles 2030a. According to various embodiments, the Arms 2020 are coupled to the Post 2010 and project laterally from the Post 2010 in different directions, such as, but not limited to, orthogonally from each other. Between the neighboring Arms 2020, the plurality of Tiles 2030a are coupled to each other and to the Arms 2020. In some embodiments, the Tiles 2030a are individual pre-fabricated hollow structures that are removably connectable to each other and to the Arms 2020. As such, the Tiles 2030a are adaptable to the type and size of the plant to be supported (e.g., for larger plants, more Tiles 2030a may be added between the Arms 2020, and for smaller plants, Tiles 2030a may be removed from between the neighboring Arms 2020). According to various embodiments, the Tiles 2030a mimic the various facets described herein in that branches of a supported plant may be woven through the Tiles 2030a, as desired, for support and guidance of plant growth. In some embodiments, the Tiles 2030a may be connectable by, for example, but not limited to, ball joints, clasps, nuts and bolts, male and female plugs, etc.

The structure of the Tile 2030a through which branches may be woven may take on a variety of forms, such as, but not limited to, arcs (2030a), triangles (2030b), circles (2030c), squares (2030d), and rectangles (2030e and 2030f). In some embodiments, such as Tiles 2030a, 2030b, 2030c, 2030d, and 2030f, a portion may be cut off or broken, as the cut away of the metal provides an easier placement of branches with less bending or potential bumping of the sites.

FIG. 21 depicts a flow chart showing a method of use of a Plant Support and Growth Directing Apparatus according to all the disclosed embodiments.

Referring to FIG. 21, a method of use 2100 may include the steps of: Selecting At Least One Post Capable Of Supporting At Least One User Selected Crown 2110; then Securing The User Selected Post(s) In Functional Proximity To A Plant To Be Supported And/Or Growth Directed 2120; then Selecting And Attaching At Least One Crown To The User Selected Post(s) 2130; then Removably Attaching To User Selected Attachment Areas Of The Crown(s) User Selected Portions Of The Plant To Be Supported And/Or Growth Directed 2140; then Abrading Or Otherwise Stressing The Plant While Attaching To The Crown(s) 2150; then Allowing For The Plant To Grow And Monitoring Placement Of Plant Within The Crown(s) 2160; then if desired growth is achieved then Removing The Plant From The Crown(s) For Intended Use 2170; or if repositioning of the plant is desired then Removing User Selected Portions Of The Plant From The Crown(s) For Reattaching 2180 and thereafter repeating steps 2140, 2150 and 2160 until the desired growth is achieved then 2170.

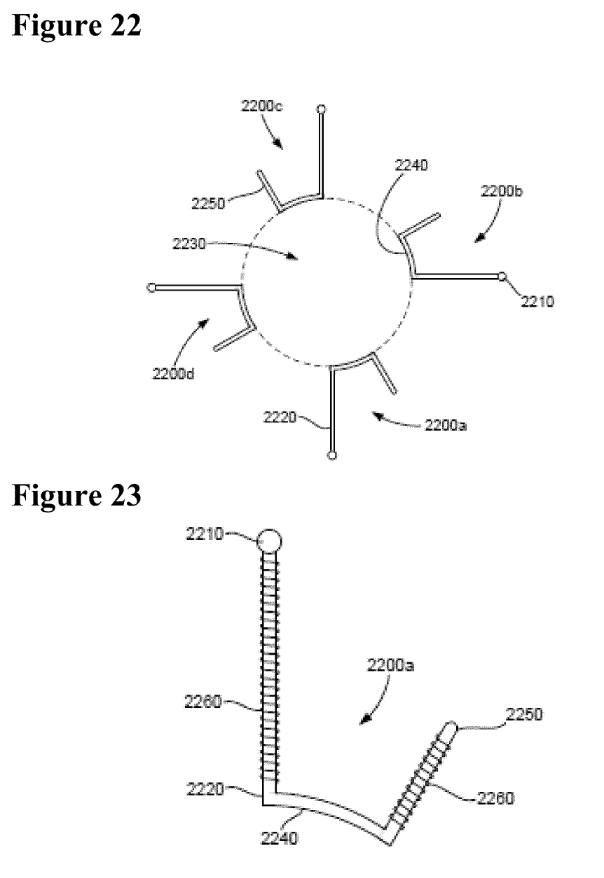

FIG. 22 depicts a top view of a Plant Support and Growth Directing Apparatus configured according to an alternative embodiment of the present invention having multiple Plant Support and Growth Directing Apparatuses.

FIG. 23 depicts an isolated top view of one of the Plant Support and Growth Directing Apparatuses of the Plant Support and Growth Directing Apparatus of FIG. 22.

Referring to FIGS. 22 and 23, an alternative embodiment of the plant support and growth directing system of the present invention utilizes a plurality of Plant Support and Growth Directing Apparatuses 2200, shown as 2200a, 2200b, 2200c and 2200d in FIG. 22, that each comprise a Post 2210, a First Arm 2220 attached to or integral with the Post 2210 so as to extend generally inwardly toward the Plant Area 2230 where the main stem of the plant will be located, a Second Arm 2240 attached to or integral with the First Arm 2220 so as to extend generally laterally from the First Arm 2220 and a Third Arm 2250 attached to or integral with the Second Arm 2240 so as to extend generally outwardly therefrom. As shown in FIG. 23, the First Arm 2220 and the Third Arm 2250 each comprise a Spring 2260. The vive portions of the plant are woven in a generally curved or circular pattern through the Springs 2260 associated with the First Arm 2220 and Third Arm 2250 so as to space these portions of the plant from each other and in spaced apart relation to the ground. Use of the plant support system shown in FIG. 22 will allow more light to hit the plant and more air to circulate through the plant, both of which will improve the growth of the plant and increase the crop from the plant. The Springs 2260 can be made out of a wide variety of materials, including metal, rubber, plastic, composites and the like. In one of the preferred embodiments, the Springs 2260 can be a rubberized coil Spring.

FIG. 24A depicts a side view of a non-adjustable tensile resistance coiled spring plant member retaining embodiment of a Plant Support and Growth Directing Apparatus.

FIG. 24B is a cutaway side view of the abrasive material coated coiled spring that comprises an elastic object capable of storing mechanical energy component of the Plant Support and Growth Directing Apparatus depicted in FIGS. 24A,C,D,E,H,I,J,K, & L.

FIG. 24C depicts a side view of an adjustable tensile resistance coiled spring plant member retaining embodiment of a Plant Support and Growth Directing Apparatus with a plant operatively attached to the apparatus with one branch of which has been supercropped.

FIG. 24D depicts a side view of an adjustable tensile resistance coiled spring plant member retaining embodiment of a Plant Support and Growth Directing Apparatus with a plant that has been harvested and remains attached to the apparatus while inverted for drying or other user desired processing of the plant.

FIG. 24E depicts a side view of an adjustable tensile resistance continuous loop plant member retaining embodiment of a Plant Support and Growth Directing Apparatus with a continuous loop variable resistance adjustment knob shown in the released position.

FIG. 24F is a cutaway side view of the adjustable tensile resistance continuous loop plant member retaining embodiment of a Plant Support and Growth Directing Apparatus with a continuous loop variable resistance adjustment knob shown in the released position thereby retaining a user selected portion of a plant by the continuous loop's tensile mechanical energy within the continuous loop.

FIG. 24G is a cutaway side view of the adjustable tensile resistance continuous loop plant member retaining embodiment of a Plant Support and Growth Directing Apparatus with a continuous loop variable resistance adjustment knob shown in the fully engaged position thereby opening the interstitial spaces between the loops thereby permitting a user selected portion of a plant to either be placed or removed from the continuous loop.

FIG. 24H is a cutaway side view of the adjustable tensile resistance coiled spring plant member retaining embodiment of a Plant Support and Growth Directing Apparatus with a coiled spring variable resistance adjustment knob shown in the released position thereby retaining a user selected portion of a plant by the coiled spring's tensile mechanical energy within the interstitial spaces between the coils of the coiled spring.

FIG. 24I is a further cutaway side view of the adjustable tensile resistance coiled spring plant member retaining embodiment of a Plant Support and Growth Directing Apparatus shown in the released position thereby retaining a user selected portion of a plant by the coiled spring's tensile mechanical energy within the interstitial spaces between the coils of the coiled spring.

FIG. 24J is a cutaway side view of the adjustable tensile resistance coiled spring plant member retaining embodiment of a Plant Support and Growth Directing Apparatus with a coiled spring variable resistance adjustment knob shown in the fully engaged position thereby opening the interstitial spaces between the loops thereby permitting a user selected portion of a plant to either be placed or removed from the interstitial spaces between the coils of the coiled spring.

FIG. 24K is a further cutaway side view of the adjustable tensile resistance coiled spring plant member retaining embodiment of a Plant Support and Growth Directing Apparatus with a coiled spring shown in the fully engaged position thereby opening the interstitial spaces between the loops thereby permitting a user selected portion of a plant to either be placed or removed from the interstitial spaces between the coils of the coiled spring.

FIG. 24L is a front view of a non-adjustable tensile resistance coiled spring plant member retaining embodiment of a Plant Support and Growth Directing Apparatus that is configured according to a second embodiment of the non-adjustable tensile resistance coiled spring plant member retaining embodiment showing use of a pivot device to allow a second arm body to pivot relative to the first arm body, with each arm body having a coiled spring.

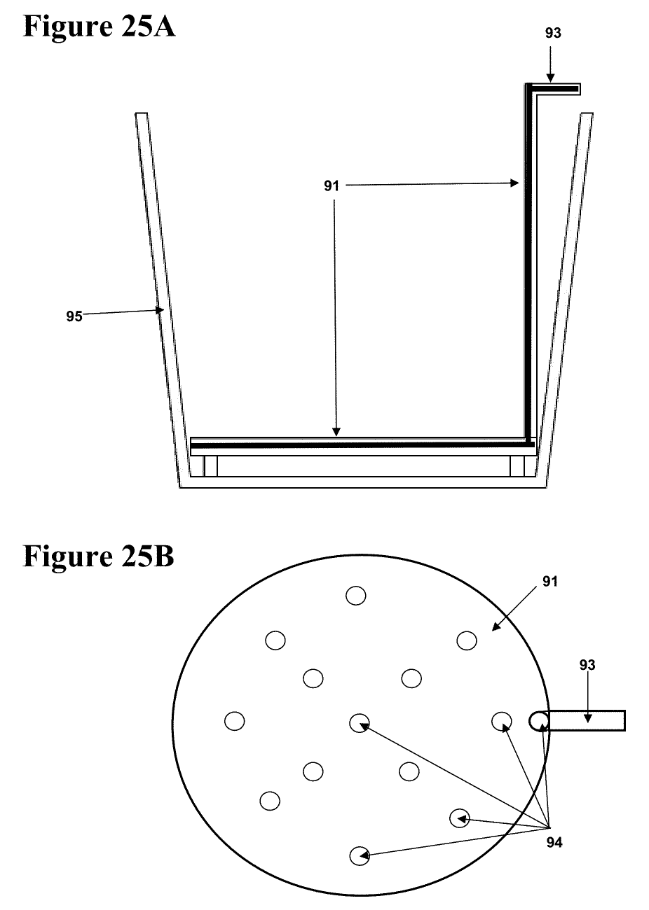

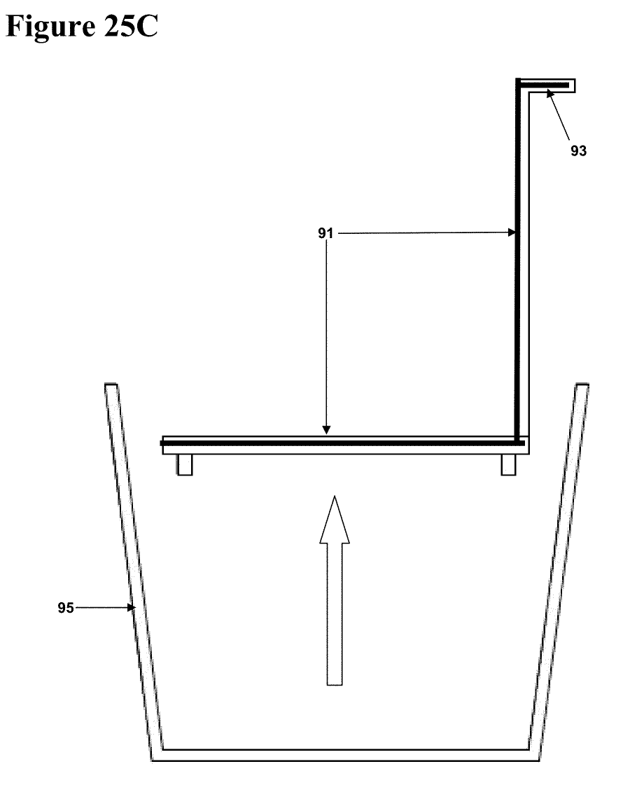

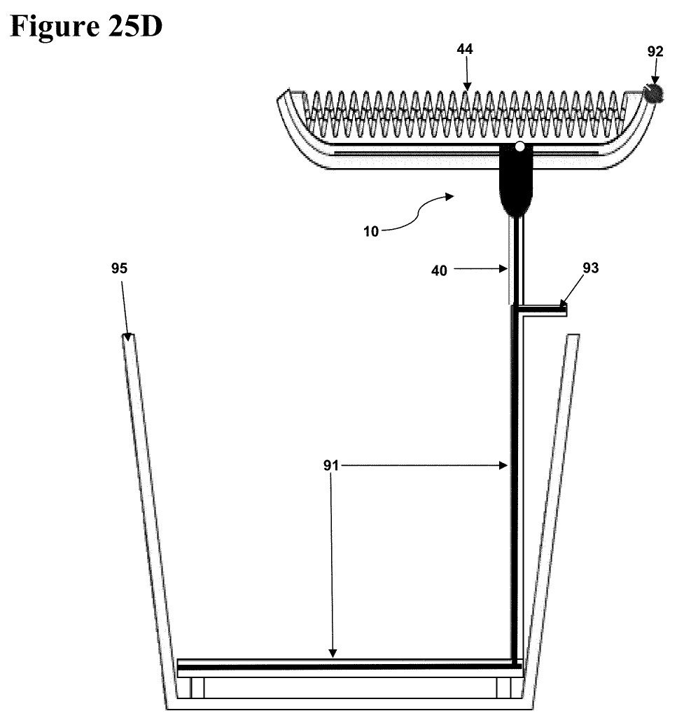

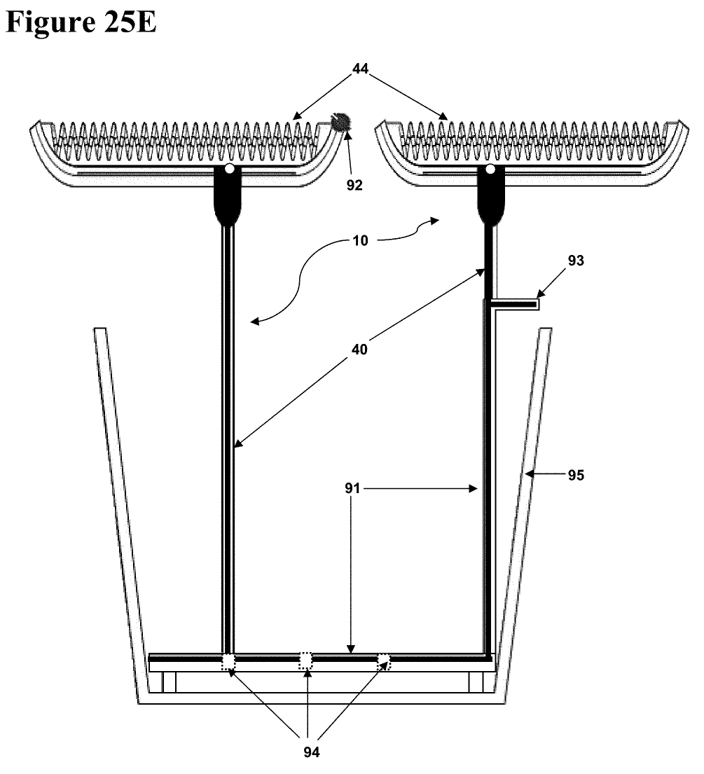

Referring to FIGS. 24A-L a Tensile Resistance Plant Member Retaining Embodiment 10 of the Plant Support and Growth Directing Apparatus of the present invention is shown in FIGS. 24A-L and FIGS. 25D-E. In this embodiment, the Tensile Resistance Plant Member Retaining Embodiment Crown 10 comprises an elongated Post 40 having an elongated Support Arm 42 attached to or integral with and extending outwardly from the Post 40, with the Support Arm 42 being structured and arranged to receive and support one or more Apical Branches 1602 of the Plant 14. In this embodiment, the Support Arm 42 comprises an Elastic Object Capable Of Storing Mechanical Energy 44, which can be a coiled spring or spring-like member, as best shown in FIGS. 24A-D, H-L and FIGS. 25D-E. The Elastic Object Capable Of Storing Mechanical Energy 44 may also be any configuration of user selected successive components of varying shapes and sizes, such as triangular or polygonal, capable of storing mechanical energy such as the Continuous Loop 44b embodiment of the Elastic Object Capable Of Storing Mechanical Energy 44 shown in FIGS. 24E-G. Disposed on the surface of the Elastic Object Capable Of Storing Mechanical Energy 44 in FIGS. 24A-D, H-L and FIGS. 25D-E and the Continuous Loop 44a embodiment of the Elastic Object Capable Of Storing Mechanical Energy 44 shown in FIGS. 24E-G is an Abrasive Surface 90 equivalent to the Abrasive Surface 260 as depicted in FIG. 2C and the Abrasive Surface 360 as depicted in FIG. 3C thereby more effectively holding a portion of a Plant 14 in a user desired position when placed there by a user. Also the Abrasive Surface 90 permits a user to controllably abrade the Plant 14 thereby stressing the Plant 14 to stimulate a desired growth response.

In another embodiment, the Support Arm 42 is configured with the features of the Elastic Object Capable Of Storing Mechanical Energy 44. The Post 40 of the Tensile Resistance Plant Member Retaining Embodiment Crown 10 comprising a Post Body 46 with a first or Lower End 48 that is, typically, inserted into or otherwise engaged with the soil in which the Plant 14 is planted or removably attached to a Removable Root Ball Support 91 as depicted in FIGS. 25D & E.

FIGS. 24E,F,G,H and J and FIGS. 25D & E depict a Tension Dial 92 operatively attached to Elastic Object Capable Of Storing Mechanical Energy 44 (44a and/or 44b) which permits a user to place and hold tension on the Elastic Object Capable Of Storing Mechanical Energy 44 (44a and/or 44b) thereby expanding the size of the interstitial space between the individual coils or loops of the Elastic Object Capable Of Storing Mechanical Energy 44 (44a and/or 44b). A user then places the desired portions of the Plant 14 or Apical Branches 1602 within user selected expanded interstitial spaces. Once the Plant 14 or Apical Branches 1602 are in the desired location the user then adjusts the Tension Dial 92 in the opposite direction thereby releasing the user applied tension to the Elastic Object Capable Of Storing Mechanical Energy 44 (44a and/or 44b) thereby contracting the interstitial spaces thereby holding the Plant 14 or Apical Branches 1602 in the user desired position(s). In the absence of the Tension Dial 92, such as depicted in FIGS. 17,18A&B, 24A,C,D&L, a user may manually place and release tension on the Elastic Object Capable Of Storing Mechanical Energy 44 (44a and/or 44b) using their hand and/or user selected tool such as a screwdriver or other rigid object. The Tension Dial 92 can be an adjustment knob, dial, lever or similar mechanism.

The Post Body 46 should be made from a material that is suitable for use around water, soil and whatever fertilizers or chemicals, if any, that will be utilized to help the Plant 14 grow, such as certain metals, plastic, fiberglass, composites, treated wood and the like. As will be readily appreciated by persons skilled in the art, virtually any material, including solid or hollow materials, can be utilized for the Post Body 46 as long as the resulting Post 40 is sufficiently stiff and strong enough to support the weight of the Support Arm 42 and Branches 24/26 and plant product produced that will be supported by the Tensile Resistance Plant Member Retaining Embodiment Crown 10. The Post Body 46 can be made in virtually any shape, including having a round, square, rectangular, oval or other shape.

In the embodiments shown in FIGS. 24A-L, the Post 40 is attached to or integral with the Support Arm 42 such that the position of the Arm Body 52, and therefore the Ends 54/56 thereof, is fixed relative to the Upper End 50 of the Post 40. In an alternative embodiment, shown in FIGS. 24C-E, an Attachment Mechanism 86 is utilized to moveably connect the Support Arm 42 to the Post 40. The Attachment Mechanism 86 shown in FIGS. 24C-E are structured and arranged to slidably interconnect the Post 40 and Support Arm 42 so as to allow the Arm Body 52 to slide relative to the Upper End 50 of Post 40 so the user can position the Support Arm 42 where it will be most beneficial for the support and growth of the plant's Apical Branches 1602 and production of product from the Plant 14. In a preferred configuration, once the Arm Body 52 is moved to a position relative to the Post 40 where the user desires to support the Apical Branches 1602 of the Plant 14, the user will be able to fix the position of the Arm Body 52 relative to the Upper End 50 of the Post 40. To allow the user to move or fix the position of the Arm Body 52 relative to the Post 40, the Attachment Mechanism 86 can include one or more Connecting Elements 88, such as a screw, bolt or the like, that is loosened or removed to slide or otherwise move the Support Arm 42 relative to the Post 40 and then tightened or reattached to fix the position of the Support Arm 42 on the Post 40. In one embodiment, during the sliding or other moving process, the Support Arm 52 will stay in engagement with the Upper End 50 of the Post 40 for ease of operation and use. Alternatively, Attachment Mechanism 86 can be configured to allow the Support Arm 42 to become fully disengaged from the Post 40 for movement by the user and then re-engaged (i.e., reattached) when the Support Arm 42 is in the desired position. As will be readily appreciated by persons skilled in the art, a variety of devices can be utilized as the Attachment Mechanism 86.

FIG. 25A is a cut away side view of a removable post stand embodiment of a Plant Support and Growth Directing Apparatus without any plant support components attached.

FIG. 25B is a top view of a removable post stand embodiment of a Plant Support and Growth Directing Apparatus without any plant support components attached depicting a plurality of post attachment holes.

FIG. 25C is a cut away side view of a removable post stand embodiment of a Plant Support and Growth Directing Apparatus without any plant support components attached depicting the removability from a pot.

FIG. 25D is a cut away side view of a removable post stand embodiment of a Plant Support and Growth Directing Apparatus with an attached adjustable tensile resistance coiled spring plant retaining member.

FIG. 25E is a cut away side view of a removable post stand embodiment of a Plant Support and Growth Directing Apparatus with two attached adjustable tensile resistance coiled spring plant retaining members.

Referring to FIGS. 25A-E a Plant Pot Removable Post System 91 of a shape and size capable of fitting into a Plant Pot 95 is depicted. One or more Posts 40 may be removably attached to the Plant Pot Removable Post System 91 in user selected locations by means of the Post Attachment Assembly(ies) 94. In the event a user is desirous of removing a planted Plant 14 with its root ball intact from the Plant Pot 95 a Handle 93 is attached to the Plant Pot Removable Post System 91 and the user may thereby lift the Plant Pot Removable Post System 91 out of the Plant Pot 95 which in turns lifts out any Plant 14 that may be planted in the Plant Pot 95. The user is then at liberty to transplant the entire assembly with the plant to another pot, or ground, or to undertake some other user desired purpose.

The component parts of the crowns of the above described embodiments may be comprised of a bendable material, such as metal, polymers, wood or the like, thereby permitting a user to make adjustments to the configuration of the apparatus while in use or preparing the apparatus for use.

Each of the posts of the above described embodiments may be comprised of two or more component parts or be telescopic thereby permitting a user to increase or decrease the length of the post such that a crown may be placed in a user desired position with respect to the plant.

According to the various embodiments of the Plant Support and Growth Directing Apparatus described herein may be utilized in conjunction with the plant cultivation techniques described above (e.g., topping, super cropping, and low stress training) to provide optimal light absorption to a supported plant. For example, a user may perform one or more of topping, super cropping, abrading and low stress training to induce lateral growth of a plant's canopy, and selectively weave the branches of the laterally growing canopy into the Plant Support and Growth Directing Apparatus according to various embodiments, as desired, to achieve optimal light absorption by the plant or other desired growth characteristics. In general each of the embodiments depicted above have a crown and a post and the crowns are each intended to be capable of being used in various combinations of the various crowns according to a user's desired use. A multiplicity of crowns may also be used and situated at different levels or planes at user desired distances which is accomplished with different lengths of posts which may be interconnected and lengthened or added to as a plant grows and additional support and direction is required by a user.

According to various embodiments, when the cannabis plant is in a “vegetation” cycle, half of the Post (e.g., in single Post designs) may be inserted into the soil, through the root mass, near the main stalk of the plant. This Post may be parallel to the plant's main stalk. Once the plant has reached a flowering stage, a second half of the Post may be connected to the lower half to form a solid pole that travels through the plant's canopy. This method may be accomplished in two parts to provide freedom to keep a light source at desired heights throughout the growing cycles. Once there is a small cluster of white pistils at the apical and auxiliary sites, about the width of a nickel, the Crown may be implemented. At this stage of growth the branches of the plant are strong and stiff, yet flexible and easily adjusted to bend without damage to the branches, and with the sites being small enough to maneuver through a rigid frame.

Various embodiments provide a modular support apparatus and method of manufacturing the same (e.g., for aiding in the growth of the Cannabis sativa and the Cannabis indica plants), which includes at least one vertical Post capable of supporting a modular collared platform that makes up the Crown of the structure and allows the branches of the plant to be woven through the structure. By weaving the branches through the Crown, the branches lay horizontally, exposing multiple (e.g., lower) sites to optimum light. Spiraling the branches around the Crown maximizes the space beneath the light's footprint, minimizing unused light. The Crown also provides support when plants (e.g., at the end of harvest) are laden with heavy flowers/fruits, as it is at this time that the flowers of the plant may become too heavy to bear its own weight. Furthermore, the plant may benefit from manipulations placed upon their branches, exposing a greater number of growth sites to needed optimum light spectrums. In addition, the Crown aids in the leveling of the growth canopy (e.g., for increasing light penetration), creating a low-stress super cropping effect on the supported plant, furthering development of the plant by opening up or broadening the canopy, and exposing lower growth sites of the plant to a light source (e.g., an overhead stationary light source).

In various embodiments, use of the Plant Support and Growth Directing Apparatus, which provides re-usable support along with the low stress super cropping effect to a supported plant, requires minimal labor. Each of the embodiments described herein, by having few components, may be implemented and assembled by a user quickly and easily without tools. When disassembled, some embodiments may be easily washed and dried by hanging the apparatus (e.g. the Facet) (e.g., on a wall or a similar vertical structure).

According to various embodiments, the Facets of the Plant Support and Growth Directing Apparatus may also provide spacing between branches. This is beneficial for providing air flow between the branches, as plants use carbon dioxide and sunlight to make their own food and to grow. As such, circulating fans may be present in grow rooms to ensure the movement of oxygen away from the plant, and to circulate carbon dioxide throughout the plant.

Because various embodiments are simple structures, they will be easily cleanable (e.g., in a dishwasher), for efficiently cleaning build-up of resins that plants naturally produce, certain foliage sprays, and potential molds and mildews (e.g., that may occur at the later stages of growth) that build up on the Plant Support and Growth Directing Apparatus. As such, sanitizing the Plant Support and Growth Directing Apparatus ensures a clean and safe support for future generations of the plants. On the other hand, other forms of support, such as netting can only be used once, and bamboo stakes only two to three times due to degradation. Furthermore, there are limitations of traditional staking devices (e.g., pole support techniques), such as the time it takes to wrap bands or tie up with twine when securing the branches to the Post or stake (e.g., there may be multiple connectors for each branch). Additionally, the wrapping or tying material used in these conventional techniques may rub against the developed flowers of the plant while being secured, resulting in damage to the plant. In addition, bamboo's hollow center may provides shelter for pests to hide in when a spray or fogger is used on the plant.

The above used terms, including “attached,” “connected,” “fastened,” “secured,” “coupled,” “integrated,” and the like are used interchangeably. In addition, while certain embodiments have been described to include a first element as being “coupled” (or “attached,” “connected,” “fastened,” etc.) to a second element, the first element may be directly coupled to the second element or may be indirectly coupled to the second element via a third element.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the previous description. The accompanying method claims present elements of the various steps in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Any actual dimensions listed are those of the preferred embodiments. Actual dimensions or exact hardware details and means may vary in a final product or most preferred embodiments and should be considered means for so as not to narrow the claims of the patent. Thus, the previous description is not intended to be limited to the implementations shown herein but is to be accorded the widest scope consistent with the principles and novel features disclosed herein. Accordingly, the scope of the invention should be determined not by the embodiments illustrated, but by the claims and their legal equivalents which accompany this application.

Having described our invention, we claim:

1. A plant support and growth directing apparatus for supporting and training at least one branch of a plant comprised of:
at least one post;
at least one post support means;
at least one crown attached to the post;
the crown being comprised of at least one component selected from at least one of the group consisting of: a support structure; a lattice with square shaped openings; a lattice with rectangular shaped openings; a lattice with triangular shaped openings; a lattice with circular shaped openings; a lattice with rounded shaped openings; a lattice with rounded shaped openings and slots disposed on at least one opening; a lattice with polygonal shaped openings; a lattice with a combination of different geometrically shaped openings; a chainmail; a bendable member capable of being bent to a user specified configuration; or an elastic object capable of storing mechanical energy having at least one interstitial space;
at least one plant stressing means; and
at least one plant positioning means attached to the component of the crown.

2. The plant support and growth directing apparatus of claim 1 wherein the elastic object capable of storing mechanical energy having at least one interstitial space is a coiled spring.

3. The plant support and growth directing apparatus of claim 1 wherein the elastic object capable of storing mechanical energy having at least one interstitial space is a series of adjacent loops.

4. The plant support and growth directing apparatus of claim 1 wherein the elastic object capable of storing mechanical energy having at least one interstitial space is a series of adjacent members of a user selected shape.

5. The plant support and growth directing apparatus of claim 1 wherein the plant stressing means is at least one component with an abrasive surface.

6. The plant support and growth directing apparatus of claim 1 wherein the plant stressing means is at least one surface of the component against which a user is able to press or bend the plant stressing the plant thereby.

7. The plant support and growth directing apparatus of claim 1 wherein the plant positioning means is at least one opening in the component selected from at least one of the group consisting of: a support structure; a lattice with square shaped openings; a lattice with rectangular shaped openings; a lattice with triangular shaped openings; a lattice with circular shaped openings; a lattice with rounded shaped openings; a lattice with rounded shaped openings and slots disposed on at least one opening; a lattice with polygonal shaped openings; a lattice with a combination of different geometrically shaped openings; or a chainmail.

8. The plant support and growth directing apparatus of claim 1 wherein the plant positioning means is at least one interstitial space of the elastic object capable of storing mechanical energy having at least one interstitial space comprising the component.

9. The plant support and growth directing apparatus of claim 1 wherein the elastic object capable of storing mechanical energy having at least one interstitial space comprising the component is further comprised of a tension adjustment means capable of placing the elastic object capable of storing mechanical energy having at least one interstitial space under tension thereby increasing the size of the interstitial space and further being capable of releasing the tension thereby decreasing the size of the interstitial space, selected from at least one of the group consisting of: an attached dial; an attached adjustable knob; an attached lever; a user's hand or finger(s); or a user selected object.

10. The plant support and growth directing apparatus of claim 1 wherein the post support means is selected from at least one of the group consisting of: a user selected portion of the soil within which the plant is planted; a tether; or a base.

11. The plant support and growth directing apparatus of claim 1 wherein the crown and the post comprise a single component.

12. The plant support and growth directing apparatus of claim 1 further comprising a crown attachment means for movably attaching the crown to the post, wherein the crown attachment means is structured and arranged to allow the crown to move relative to the post.

13. The plant support and growth directing apparatus of claim 1 wherein at least one component of the crown is further comprised of at least one pivotable portion.

14. The plant support and growth directing apparatus of claim 1 wherein the post is comprised of at least two parts capable of being assembled together or disassembled thereby permitting a user to assemble or disassemble the post to a user desired length.

15. The plant support and growth directing apparatus of claim 1 wherein the post is telescopic.

16. A method of using the plant support and growth directing apparatus of claim 1 consisting of the steps of:
selecting the post of a user desired length;
attaching the post to the user selected post support means;
selecting at least one crown of a user desired configuration;
attaching the crown to the post;
adjusting the crown to a user desired position;
positioning at least one user selected portion of the plant to the plant positioning means in a user defined configuration to support and direct the growth of the plant in a manner desired by the user;
stressing the user selected portion of the plant to stimulate a user desired response from the plant;
permitting the plant a user desired period of time to grow;
removing the user selected portion of the plant from the plant positioning means if a user desired growth has been achieved and/or the user desires to harvest the plant and if the user desired growth has not been achieved and repositioning is desired by the user then;
repositioning at least one user selected portion of the plant to the plant positioning means in a user defined configuration to support and direct the growth of the plant in a manner desired by the user; and/or
increasing the length of the post to form a lengthened post of a user desired length;
selecting at least one additional crown of a user desired configuration;
attaching the additional crown to the lengthened post;
adjusting the additional crown to a user desired position;
positioning at least one user selected portion of the plant to the plant positioning means of the additional crown in a user defined configuration to support and direct the growth of the plant in a manner desired by the user; and
repeating one or more of the steps of the method until the user desired growth has been achieved and/or the user desires to harvest the plant.
